(19) United States
(12) Patent Application Publication
(10) Pub. No.: US 2022/0321057 A1
(43) Pub. Date: Oct. 6, 2022

(54) DISTRIBUTED FLEXIBLE MEMBRANE BACKING SYSTEMS, DEVICES, AND METHODS

(71) Applicant: Roccor, LLC, Longmont, CO (US)

(72) Inventors: Bryan Mazor, Denver, CO (US); Thomas Jeffrey Harvey, Nederland, CO (US); Toby Harvey, Enoch, UT (US); Zachary McConnel, Longmont, CO (US); Maegan Gilmour, Broomfield, CO (US)

(21) Appl. No.: 17/712,569

(22) Filed: Apr. 4, 2022

Related U.S. Application Data
(60) Provisional application No. 63/170,136, filed on Apr. 2, 2021.

(51) Int. Cl. H02S 30/20

(52) U.S. Cl. CPC H02S 30/20

(57) ABSTRACT

Distributed flexible membrane backing systems, devices, and methods are provided in accordance with various embodiments. Some embodiments utilize distributed backing structures in lieu of a central boom technology or rigid panel structure. Disaggregating the structural component generally allows the structure mass and volume to be distributed more efficiently across the backside of the flexible membrane, such as a photovoltaic membrane. This distribution generally enables an increased number of structural support points (within the deployed flexible membrane), which may increase the performance of the flexible membrane. Some embodiments interface the structure and the membranes throughout the entire surface of the deployed membrane. The distribution of structure may allow more efficient stowage of the deployable structure. This distributed backing structures may allow for increased structural depth to be achieved, effectively creating a deep deployed truss on the backside of the deployed membrane, such as a solar array or antenna.

### CROSS-REFERENCES TO RELATED APPLICATIONS

This application is a non-provisional patent application claiming priority benefit of U.S. provisional patent application Ser. No. 63/170,136 filed on Apr. 2, 2021 and entitled “DISTRIBUTED FLEXIBLE MEMBRANE BACKING SYSTEMS, DEVICES, AND METHODS,” the entire disclosure of which is herein incorporated by reference for all purposes.

### GOVERNMENT LICENSE RIGHTS

This invention was made with Government support under Contract NR0000-20-C-0087 awarded by the National Reconnaissance Office. The Government has certain rights in the invention.

### BACKGROUND

A variety of challenges may arise when deploying flexible membranes (such as solar array blankets or antennas). Boom deployers, for example, generally do not scale down very well, which may be cumbersome and/or may utilize a large amount of volume. It may also be difficult to tie into a midspan of an array. Furthermore, use of a boom deployer typically uses one or more spreaders that are generally limited to a root and tip of the array. Booms also may be tensioned out globally, which generally drives up performance requirements.

There may be a need for new tools and techniques to address these challenges.

### SUMMARY

Flexible membrane systems, devices, and methods are provided in accordance with various embodiments. For example, some embodiments include a flexible membrane system that may include one or more flexible membranes and multiple distributed backing structures coupled with at least one of the one or more flexible membranes to form multiple sections from the at least one of the one or more flexible membranes. In some embodiments, the multiple sections define multiple bays of the flexible membrane system. In some embodiments, the one or more flexible membranes may include multiple flexible membranes. In some embodiments, the one or more flexible membranes include at least one flexible membrane that is formed from multiple membrane segments; each membrane segment may be associated with a respective section. In some embodiments, the one or more flexible membranes include one or more solar array blankets.

In some embodiments of the system, the multiple distributed backing structures include multiple foam panels. The multiple foam panels may be positioned with respect to one or more folds of the at least one of the one or more flexible membranes in a stowed state such that one or more elements of the at least one of the one or more flexible membranes are protected in the stowed state. The one or more elements may include photovoltaic cells, for example. The multiple foam panels may extend perpendicular to the at least one of the one or more flexible membranes in a deployed state.

Some embodiments of the system include one or more compression panels that compress the at least one of the one or more flexible membranes and the multiple backing structures together in a stowed state. The one or more compression panels may unfold during deployment of the flexible membrane system and remain at a root of the flexible membrane system during the deployment. Some embodiments include multiple foam panels positioned with respect to one or more folds of the at least one of the one or more flexible membranes in the stowed state such that one or more elements of the at least one of the one or more flexible membranes are protected in the stowed state.

In some embodiments of the system, the multiple distributed backing structures include multiple bowed battens that apply tension to the at least one of the one or more flexible membranes that provide deployment force within the multiple sections formed from the at least one of the one or more flexible membranes. The multiple bowed battens may include multiple pairs of bowed battens where each pair of bowed battens may form a crossed configuration for a respective section from the multiple sections of the at least one of the one or more flexible membranes. Some embodiments include one or more foam panels from multiple foam panels that include one or more channels that accommodate one or more of the bowed battens in the stowed state. In some embodiments, the multiple distributed backing structures include one or more torque springs that push the multiple sections apart from each other during deployment. In some embodiments, the multiple distributed backing structures include one or more longerons that are put under tension from the one or more torque springs as each section from the multiple sections deploy. In some embodiments, the one or more longerons include one or more tensioned cords. In some embodiments, the multiple distributed backing structures include one or more diagonals that are tensioned by at least the one or more bowed battens or the one or more torque springs and form a distributed truss structure with the one or more longerons.

In some embodiments of the system with multiple bowed battens, the multiple distributed backing structures include one or more longerons and one or more diagonals that form a distributed truss structure; the one or more diagonals and the one or more longerons are tensioned by the one or more bowed battens. Some embodiments of the system with multiple bowed battens include one or more snubbers positioned to separate the one or more of the multiple bowed battens from the at least one of the one or more flexible membranes. In some embodiments, the one or more snubbers may also separate the one or more torsion springs from the at least one of the one or more flexible membranes.

Some embodiments of the system include one or more latches that control sequential deployment of one or more of the sections from the multiple sections of at least one of the one or more flexible membranes. In some embodiments of the system, the one or more flexible membranes are configured to Z-fold. Some embodiments of the system include one or more lanyards that control deployment of the multiple sections of the at least one of the one or more flexible membranes.

In some embodiments of the system, the one or more flexible membranes include a first flexible membrane as the at least one of the one or more flexible membranes and a second flexible membrane such that the second flexible membrane is stacked in a folded state on the first flexible membrane in a folded state. The first membrane and the second membrane may be coupled with each other through one or more hinges coupled with one or more foam panels coupled with the first membrane and one or more foam panels coupled with the second membrane. In some embodiments, the second flexible membrane is tensioned from a root section of the second flexible membrane to a tip section of the second flexible membrane. Some embodiments of the system include one or more arm attachments coupled with one or more outer corners of at least the tip section of the second flexible membrane such that one or more wrinkles in the second flexible membrane are reduced. In some embodiments, one or more arm attachments are coupled with one or more outer corners of at least the root section of the second flexible membrane such that one or more wrinkles in the second flexible membrane are reduced.

Some embodiments include a method of deployment of a flexible membrane system that may include deploying multiple sections of a flexible membrane utilizing multiple distributed backing structures coupled with the flexible membrane to form the multiple sections of the flexible membrane. Some embodiments of the method include applying tension to the flexible membrane through multiple bowed battens from the multiple distributed backing structures that provide deployment force within the multiple sections of the flexible membrane. Some embodiments of the method include applying tension to one or more diagonals coupled with the flexible membrane through one or more of the bowed battens. Some embodiments include comprising pushing the multiple sections of the flexible membrane apart from each other during deployment utilizing one or more torque springs from the multiple distributed backing structures. Some embodiments of the method include tensioning one or more longerons utilizing the one or more torque springs as each section from the multiple sections of the flexible membrane deploys. In some embodiments, the one or more longerons include one or more tensioned cords.

Some embodiments of the method include folding the flexible membrane into a stowed state such that the multiple foam panels coupled with the flexible membrane are positioned within one or more folds of the flexible membrane such that multiple elements of the flexible membrane are protected in the stowed state. Some embodiments of the method include extending the multiple foam panels perpendicular to the flexible membrane in a deployed state. Some embodiments of the method include compressing the flexible membranes and the multiple foam panels together in a stowed state utilizing one or more compression panels. Some embodiments of the method include unfolding the one or more compression panels during deployment of the flexible membrane where the one or more compression panels remain at a root of the flexible membrane during the deployment.

Some embodiments of the method include deploying the multiple sections of the flexible membrane sequentially. Some embodiments of the method include utilizing one or more latches to sequentially deploy one or more of the sections from the multiple sections of the flexible membrane. In some embodiments, at least one of the one or more latches controls deployment of a tip section of the multiple sections of the flexible membrane. In some embodiments, the at least one of the one or more latches that controls deployment of the tip section of the multiple sections of the flexible membrane is coupled with a penultimate section of the multiple sections of the flexible membrane with a tether.

Some embodiments of the method include separating one or more of the multiple bowed battens from the flexible membrane using one or more snubbers. Some embodiments of the method include positioning at least a portion of one or more of the multiple bowed battens within one or more channels formed in one or more of the multiple foam panels in the stowed state.

Some embodiments of the method include another flexible membrane in a folded state stacked on the flexible membrane in a folded state. Some embodiments of the method include rotating the other flexible membrane in the folded state to position lateral to the flexible membrane in the folded state for deployment and deploying the other flexible membrane as the multiple sections of the flexible membrane are deployed. Some embodiments of the method include tensioning the other flexible membrane from a root of the other flexible membrane to a tip of the other flexible membrane. Some embodiments of the method include reducing one or more wrinkles of the other flexible membrane utilizing one or more arm attachments coupled with one or more outer corners of the tip section of the other membrane.

Some embodiments include methods, systems, and/or devices as described in the specification and/or shown in the figures.

The foregoing has outlined rather broadly the features and technical advantages of embodiments according to the disclosure in order that the detailed description that follows may be better understood. Additional features and advantages will be described hereinafter. The conception and specific embodiments disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows aspects of a system in accordance with various embodiments.

FIG. 2A and FIG. 2B show aspects of a system in accordance with various embodiments.

FIG. 3A and FIG. 3B show aspects of systems in accordance with various embodiments.

FIG. 4 shows aspects of a system in accordance with various embodiments.

FIG. 5 shows aspects of a system in accordance with various embodiments.

FIG. 6 shows aspects of a system in accordance with various embodiments.

FIG. 7 shows aspects of a system in accordance with various embodiments.

FIG. 8 shows aspects of a system in accordance with various embodiments.

FIG. 9A, FIG. 9B, FIG. 9C, and FIG. 9D show aspects of systems in accordance with various embodiments.

FIG. 10A, FIG. 10B, and FIG. 10C show aspects of a system in accordance with various embodiments.

FIG. 11A, FIG. 11B, and FIG. 11C show aspects of a system in accordance with various embodiments.

FIG. 12 shows aspects of a system in accordance with various embodiments.

FIG. 13A and FIG. 13B show aspects of a system in accordance with various embodiments.

FIG. 14A and FIG. 14B show aspects of a system in accordance with various embodiments.

FIG. 15A, FIG. 15B, and FIG. 15C show aspects of a system in accordance with various embodiments.

FIG. 16A and FIG. 16B shows aspects of systems in accordance with various embodiments.

FIG. 17A shows a flow diagram of a method in accordance with various embodiments.

FIG. 17B shows a flow diagram of a method in accordance with various embodiments.

### DETAILED DESCRIPTION

This description provides embodiments, and is not intended to limit the scope, applicability, or configuration of the disclosure. Rather, the ensuing description will provide those skilled in the art with an enabling description for implementing embodiments of the disclosure. Various changes may be made in the function and arrangement of components.

Thus, various embodiments may omit, substitute, or add various procedures or components as appropriate. For instance, it should be appreciated that the methods may be performed in an order different than that described, and that various stages may be added, omitted, or combined. Also, aspects and elements described with respect to certain embodiments may be combined in various other embodiments. It should also be appreciated that the following systems, devices, and methods may individually or collectively be components of a larger system, wherein other procedures may take precedence over or otherwise modify their application.

Lightweight, compact, flexible membrane backing systems, devices, and methods are provided in accordance with various embodiments. The flexible membranes may include, but are not limited to, solar array blankets or antenna structures. Some embodiments utilize a distributed backing structure in lieu of a central boom technology or rigid panel structure. Disaggregating the structural components generally allows the structure's mass and volume to be distributed more efficiently across the backside of the flexible membrane, such as a photovoltaic membrane. This distribution generally enables an increased number of structural support points (within the deployed flexible membrane), which may increase the performance of the flexible membrane; a traditional flex-blanket array, for example, generally interfaces the structure to the blanket at the tip and the root of the structure. Some embodiments interface the structure and the membranes throughout the entire surface of the deployed membrane. The distribution of the structure may also allow more efficient stowage of the deployable structure. For example, this may allow for eliminating a boom canister of a centralized boom deployer. This distributed backing structures also may allow for increased structural depth to be achieved, effectively creating a deep deployed truss on the backside of the deployed membrane, such as a solar array or antenna.

Some embodiments provide additional innovations. For example, distribution of the structure may enable reduced tension levels in the flexible membrane (e.g., solar array or antenna blankets) as tension may be applied locally across a smaller area (to control the mass of the flexible blanket, for example) compared to a traditional approach of applying a global tension to the blanket as a means for tension stabilization of the entire structure. Some embodiments are inherently modular (as each bay may create a stand-alone structural element, for example). This may allow the flexible membrane(s) to be scaled upwards and downwards with minimal limitation. Some embodiments are inherently fault-tolerant and/or resilient. The distributed backing structure may be effectively several “quasi-independent” structural bays. If one of these bays fails to deploy and/or fails on orbit, there may be minimal overall global loss of performance (as the other bays still maintain their performance).

Some embodiments utilize flexible blanket array(s) for small satellites, which may be lightweight and packable. One challenge that may be faced with deployment may arise with the use of a boom deployer that may push the blanket array stack out. Boom deployers, however, generally do not scale down very well, which may be cumbersome and/or utilize a large amount of volume. It may also be difficult to tie into a midspan of the array. Furthermore, the use of a boom deployer typically uses one or more spreaders that are generally limited to the tip and root of the array. Booms also are generally tensioned out globally, which may drive up performance requirements. Furthermore, the use of a boom or other truss structure is typically hard to integrate with flexible membranes. They are typically offset from the flexible membranes, which may result in a large volume and/or footprint for stowed systems.

The systems, devices, and methods provided may instead spread mass out over back of flexible membrane(s), with pick up locally. As a result, some embodiments do not need to utilize high tension. Locally tensioning out the blanket may facilitate making sure it is pointed. Some embodiments provide a more optimized structure and system for packaging; for example, various elements may interweave between folds of the flexible membrane(s). This may eliminate large volume issues for deployer. Some embodiments provide integrally stowed backing with the flexible membrane(s). Some embodiments fold the distributed backing components with the flexible membranes, which may reduce the footprint and/or volume of the stowed system. Some embodiments pick up the flexible membranes at multiple points. The backing components may be integrally folded within folds of flexible membranes. Some embodiments utilize one or more compression panels when stowed that may increase the footprint of the deployed system, while leaving the compression panel mass at the root for deployment.

Distributed flexible membrane backing systems, devices, and methods are provided in accordance with various embodiments. Embodiments generally include one or more flexible membranes, such as flexible solar array blankets or antenna structures. The flexible membranes may be configured to z-fold for stowage. The distributed backing components may pick up the flexible membranes along numerous points of the flexible membranes.

The distributed flexible membrane backing structures generally include one or more foam panels. The foam panel(s) may be integrally coupled with the flexible membrane(s) for stowage. The foam panel(s) may help protect the elements of the flexible membrane(s), such as solar cells, when packaged and launched. The foam panel(s) may include cut out or material-less portions that may accommodate various structural elements, such as batten(s). This may further facilitate protecting elements of the flexible membrane(s) against being damaged when the components are stowed together and/or launched. The foam panel(s) may be sandwiched between folded portions of the flexible membrane(s) for stowage, launch, and/or deployment.

The foam panel(s) may be considered as part of the distributed backing structures. The foam panel(s) may provide structure depth and/or rigidity for the systems when deployed. The foam panel(s) may also pick up the flexible membrane(s) locally at multiple distributed locations on the back of the flexible membrane(s). This may help relax the structural requirements of the systems, devices, or methods as one may not have to drive high tensions when only coupling with a root and tip of a system. The foam panel(s) may also provide support out to the edges of the flexible membranes.

The foam panel(s) may provide for tension locally with respect to the one or more flexible membranes. The foam panel(s) may be coupled with the flexible membrane(s) utilizing a variety of rigid components, such as spreader bars, edge frames, or beams along the base of the foam panel(s). The foam panel(s) along with providing distributed support points may also provide structural depth.

The foam panel(s) may provide other benefits, such as not blocking sunlight as they are generally perpendicular to the flexible membrane(s) in a deployed state. The foam panel(s) may force the first mode shape of one or more of the tensioned flexible membrane(s) to be the stretched distance for each section or bay, such as between successively deployed foam panels, rather than a total distance from a root to a tip of the deployed system.

Some embodiments include one or more compression panels, which may allow for the various components, such as the flexible membrane(s) and foam panel(s) to be down and squeezed for launch. The compression panel(s) may be rigid and/or stiff and contain enough mass to facilitate the compression of the various components.

The compression panel(s) may flip open for deployment of the flexible membrane(s) along with the foam panel(s). The compression panel(s) may remain at the root of the system as a result, such that the compression panel(s) do not have to be deployed to the tip of the deployed structure. Through being configured to flip open, the compression panel(s) may also facilitate increasing the number of flexible membranes utilized in the various systems, devices, and methods provided.

Some embodiments include one or more truss lattice structures that may be coupled with the back side of one or more of the flexible membranes. Some embodiments include a single central truss lattice structure coupled with one or more of the flexible membranes. The use of truss lattice structure(s) may provide for multiple pick up or touching points with respect to one or more of the flexible membranes. The truss lattice structure(s) may be included as part of the distributed backing structure. In some embodiments, the truss(es) are formed from fiberglass and may provide reinforcement and support for one or more of the flexible membranes coupled with the truss(es). In some embodiments, the truss(es) act as a boom structure. Some embodiments include a lattice truss structure coupled with one or more central flexible membranes, while outer flexible membranes (or outer columns) may not include a lattice truss structure, though some embodiments utilize lattice truss structures with respect to outer column membranes.

Some embodiments utilize a variety of other components that may provide for distributed support and/or distributed deployment force components. For example, some embodiments include one or more bowed battens that may facilitate deployment of individual sections or bays of the flexible membrane(s). Some embodiments also utilize one or more tensioned diagonals. Some embodiments utilize one or more longerons that may go from section to section (or bay to bay). The longeron(s) may be configured as tensioned cords, which may include a Kevlar cord.

Some embodiments utilize one or more torque springs that may be coupled with respect to one or more of the foam panels and/or one or more of the battens to facilitate deployment. The torque spring(s) may be positioned at the base of the batten(s). The batten(s) may help tension the flexible membrane(s) and/or the diagonal(s), and/or the longeron(s). The torque spring(s) from section to section (or bay to bay) may be utilized to help push the sections or bays apart during deployment. The torque spring(s) may act as kicker springs to initiate deployment. Variations in torque spring force may be used to influence deployment sequence. The torque spring(s) may push against the bowed batten(s) and/or foam panel(s). The combination of bowed batten(s) and torque spring(s) may provide in effect two sets of springs to facilitate deployment. The bowed batten(s) may provide deployment force within individual sections or bays, while torque spring(s) may provide deployment force between sections or bays.

Some embodiments include one or more wiper arm outer column attachments that may be attached to outer corners of one or more of the flexible membranes, such as outer columns of the system, which may help reduce wrinkles in the flexible membrane(s). The wiper arm outer column attachment may include a bar or beam portion along with a spreader portion to help reduce wrinkles in outer column flexible membrane(s). This may provide for an even load distribution along the length of the outer column flexible membrane.

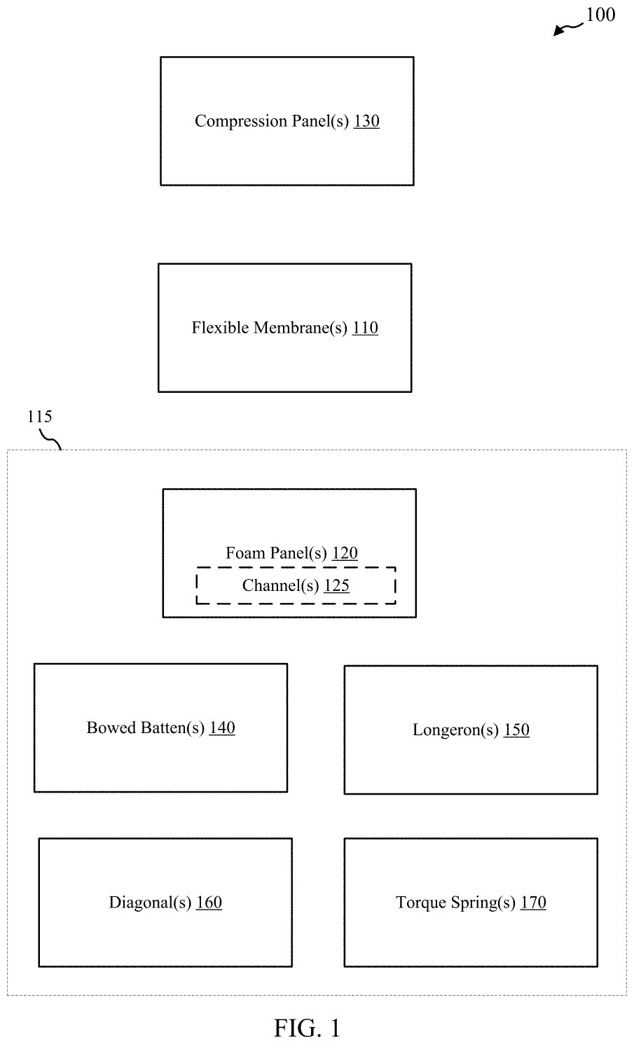

Turning now to FIG. 1, a distributed flexible membrane backing system 100 is provided in accordance with various embodiments. System 100 may also be referred to as a flexible membrane system and/or flexible membrane support system. The system 100 generally includes one or more flexible membranes 110. The flexible membrane(s) 110 may be referred to as blankets, such as solar array blankets. Some embodiments utilize multiple flexible membranes. Some embodiments include one or more flexible photovoltaic arrays, which may include multiple solar cells on Kapton. The flexible membrane(s) 110 may also be configured as antenna components, such as a phase-array antenna. The flexible membrane(s) 110 may be configured as single layer or multiple layer membrane structures. Some embodiments utilize a flexible membrane 110 that may include multiple membrane segments, where each segment may correspond to a section or bay of the system.

The flexible membrane(s) 110 may be configured to z-fold for stowage. As will be discussed further below, one or more of the distributed backing structures 115 may pick up the flexible membrane(s) 110 along numerous points of the flexible membrane(s) 110.

System 100 may include multiple distributed backing structures 115 that may be coupled with at least one of the one or more flexible membranes 110 to form multiple sections from the at least one of the one or more flexible membranes 110. In some embodiments, the multiple sections define multiple bays of the flexible membrane system.

System 100 may include one or more foam panels 120 as part of the multiple distributed backing structures 115. Some embodiments include multiple foam panels 120, which may be configured to be foldable. The foam panels 120 may be referred to as lateral foam panels. The foam panels 120 may help protect the elements of the flexible membrane 110, such as solar cells, when packaged and launched. The one or more foam panels 120 may include cut out or material-less portions 125 (which may also be referred to as channels) that may accommodate various structural elements, such as bowed batten(s) 140 and/or torque spring(s) 170. This may further facilitate protecting elements of the flexible membrane(s) 110 against being damaged by elements such as bowed batten(s) 140 and/or torque spring(s) 170 when the components are stowed together and/or launched. In general, the foam panel(s) 120 may be positioned with respect to one or more folds of the at least one of the one or more flexible membranes 110 in a stowed state such that one or more elements of the at least one of the one or more flexible membranes 110 are protected in the stowed state. The one or more elements may include photovoltaic cells, for example. The foam panel(s) 120 may extend perpendicular to the at least one of one or more flexible membranes 110 in a deployed state.

As noted above, the one or more foam panels 120 may be considered as part of the multiple distributed backing structures 115. The one or more foam panels 120 may provide structure depth and/or rigidity to the system 100 when deployed. The one or more foam panels 120 may also pick up the one or more flexible membranes 110 locally. The use of multiple foam panels 120 may facilitate picking up the one or more flexible membranes 110 at multiple distributed locations on the back of the one or more flexible membranes 110. This may help relax the structural requirements of the system 100 as one may not have to drive high tensions when only coupling with a root and tip. The one or more foam panels 120 may also provide support out to the edges of the one or more flexible membranes 110.

The one or more foam panels 120 may be coupled with the one or more flexible membranes 110 as part of a distributed backing structure that picks the flexible membrane(s) 110 up at multiple points. In some embodiments, this is configured as evenly distributed touch points along back of flexible membrane(s) 110, rather than just at the root and tip of the flexible membrane(s) 110. The use of the distributed backing structure may allow modular and scalable approaches. For example, additional bays may be added. The resulting systems may provide better performance.

The one or more flexible membranes 110 may be configured to integrally fold with the one or more foam panels 120. The folding may be configured such that a V-fold is formed in a flexible membrane 110 between two or more foam panels 120 when stowed. For example, one or more creases may be formed in each flexible membrane 110, such as at a midpoint between two foam panels 120, which may allow the flexible membrane 110 to fold between the two foam panels 120 for storage. The distributed backing structure 115 may thus fold integrally with the flexible membrane 110. The one or more flexible membranes 110 may include a crease along their respective mid points, which may allow them to fold up between one or more foam panels 120. In the case of photovoltaic blankets, photovoltaic cells may be placed face to face when stowed. Other components such as bowed batten(s) 140, longeron(s) 150, and/or diagonal(s) 160 may be coupled on the backside (support side) of the flexible membranes 110. As noted above, cut outs or channels in the foam panel(s) 120 may accommodate some of these components, such as the batten(s) 140.

The use of one or more foam panels 120 may provide for tension locally with respect to the one or more flexible membranes 110. The foam panel(s) 120 may be coupled with the flexible membrane 110 utilizing a variety of rigid components, such as spreader bars, edge frames, or beams along the base of the foam panel(s) 120. The one or more flexible membranes 110 may be tensioned out locally with the coupling between one or more components of the foam panel(s) 120. The foam panel(s) 120 along with providing distributed support points also may provide structural depth. Some embodiments utilize a C-channel beam that the foam panel(s) 120 may fit down into. The spreader bars, edge frames, or beams (such as cross beams) may provide a rigid interface between the foam panel(s) 120 and the flexible membrane(s) 110.

Some embodiments provide benefits over more conventional systems that may utilize spreader bars at a root and tip of a flexible membrane 110. Some embodiments include foam panels 120 distributed at each bay. This generally allows for pick up points distributed along the back of the flexible membrane(s) 110 rather than just the root and tip. The systems, devices, and methods may thus provide distributed support points from beam(s), foam panel(s), and/or lattice truss(es). These various components may help locally tension out the flexible membrane(s) 110.

The foam panel(s) 120 may provide other benefits, such as not blocking sunlight as they are generally perpendicular to the flexible membrane(s) 110 in a deployed state. The foam panel(s) 120 may also have hinges on them. Each element may act as a support point. The foam panel(s) 120 may force the first mode shape of the tensioned flexible membrane(s) 110 (such as the outer flexible membrane(s)) to be the stretched distance for each bay, such as between successively deployed foam panels, rather than the total distance from the root to the tip of the deployed system.

Some embodiments of system 100 include one or more compression panels 130, which may allow for the various components, such as the one or more flexible membranes 110 and one or more foam panels 120 to be held down and squeezed for launch. The one or more compression panels 130 may be honeycombed. The one or more compression panels 130 may be rigid and/or stiff and contain enough mass to facilitate the compression of the various components.

The one or more compression panels 130 may flip open for deployment of the one or more flexible membranes 110 along with the one or more foam panels 120. The one or more compression panels 130 may remain at the root of the system 100 as a result, such that the one or more compression panels 130 do not have to be deployed to the tip of the deployed structure. Through being configured to flip open, the one or more compression panels 130 may also facilitate increasing the number of flexible membranes 110 utilized in the various systems, devices, and methods provided without significant increase to the stowed footprint.

Some embodiments of system 100 include one or more truss lattice structures that may be coupled with the back side of one or more of the flexible membranes 110. Some embodiments include a single central truss lattice structure coupled with one or more of the flexible membranes 110. Some embodiments include multiple truss lattice structures coupled with multiple flexible membranes 110. The use of one or more truss lattice structures may provide for multiple pick up or touching points with respect to one or more of the flexible membranes 110. The one or more truss lattice structures may be included as part of the distributed backing structure 115. In some embodiments, the truss structures are formed from fiberglass and may provide reinforcement and support for one or more of the flexible membranes 110 coupled with the truss(es). In some embodiments, the truss(es) act as a boom structure. Some embodiments include a lattice truss structure coupled with one or more central flexible membranes 110, while outer flexible membrane(s) 110 (or outer columns) may not include a lattice truss structure, though some embodiments utilize lattice truss structures with respect to outer column membrane(s) 110.

Some embodiments of system 100 utilize a variety of other components that may provide for distributed backing structures 115, which may also be referred to as distributed support and/or distributed deployment force components. For example, some embodiments include one or more bowed battens 140 that may facilitate deployment of individual sections (or bays) of the flexible membranes 110. The bowed batten(s) 140 may be referred to as buckled batten(s). In general, the bowed batten(s) 140 apply tension to the at least one of the one or more flexible membranes 110 that provide deployment force within the multiple sections formed from the at least one of the one or more flexible membranes 110. The multiple bowed battens 140 may include multiple pairs of bowed battens where each pair of bowed battens may form a crossed configuration for a respective section from the multiple sections of the at least one of the one or more flexible membranes 110. As noted above, some embodiments include one or more foam panels 120 from the multiple foam panels that include one or more channels 125 that accommodate one or more of the bowed battens 140 and/or torque springs 170 in the stowed state.

In some embodiments of system 100, the multiple distributed backing structures 115 include one or more torque springs 170 that push the multiple sections apart from each other during deployment. In some embodiments, the multiple distributed backing structures 115 include one or more longerons 150 that are put under tension from the one or more torque springs 170 and/or the one or more bowed battens 140 as each section from the multiple sections deploy. The one or more longerons 150 may go from section to section of the system 100. In some embodiments, the one or more longerons 150 include one or more tensioned cords; in some embodiments, the longeron(s) 150 as tensioned chords may include Kevlar cords. In some embodiments, the multiple distributed backing structures include one or more diagonals 160 that are tensioned by at least the one or more bowed battens 140 or the one or more torque springs 170 and form a distributed truss structure with the one or more longerons 150.

The one or more torque springs 170 may be coupled with respect to the one or more foam panels 120 and/or one or more bowed battens 140 to facilitate deployment. The one or more torque springs 170 may be posed at the base of the battens 140. In some embodiments, the one or more torque springs 170 are coupled with one or more cross beams coupled with a base of a foam panel 120.

The one or more bow battens 140 may help tension the one or more flexible membranes 110, the one or more diagonals 160, and/or the one or more longerons 150. The one or more torque springs 170 may also facilitate tensioning different components, such as the one or more longerons 150 as tensioned cables; the torque spring(s) 170 may also help tension the diagonal(s) 160. The one or more torque springs 170 from section to section (or bay to bay) may be utilized to help push the sections apart during deployment. The one or more torque springs 170 may act as kicker springs to initiate deployment. The one or more torque springs 170 may push against the bowed batten(s) 140 and/or foam panel(s) 120. The combination of bowed batten(s) 140 and torque spring(s) 170 may provide in effect two sets of springs to facilitate deployment. The bowed batten(s) 140 may provide deployment force within individual sections or bays, while torque spring(s) 170 may provide deployment force between sections. Longeron(s) 150 may run from section to section or bay to bay. The torque spring(s) 170 may also be referred to torque rod spring(s), torsion spring(s), torsion rod spring(s), torque bar(s), and/or torsion bar(s).

In some embodiments of the system 100 with multiple bowed battens 140, the multiple distributed backing structures 115 include one or more longerons 150 and one or more diagonals 160 that form a distributed truss structure; the one or more diagonals 160 and one or more longerons 150 may be tensioned by the one or more bowed battens 140. In some embodiments, the one or more longerons 150 may facilitate tensioning the diagonal(s) 160. For example, some embodiments utilize a foldable cross-sectionally stiff members as longeron(s) 150, such as foldable tube(s) with dog bone hinge(s).

Some embodiments of system 100 include multiple flexible membranes 110 that may include one wide base flexible membrane (which may be referred to as a central membrane) and two half side panels (which may be referred to as outer membranes) that may flip in for stowage and then flip out for deployment. Foam panel(s) 120 may be sandwiched with the flexible membrane(s) 110 to compress the flexible membrane(s) 110 (and their solar cells, for example) so that they do not break with the aid of the one or more compression panels. The compression panel(s) 130 may flip out and stay at the base and keep the moment of inertia low. Structures with less mass may hold the flexible membrane(s) 110 out. For example, the one or more flexible membranes 110 include a first flexible membrane (which may be referred to as a central membrane) as the at least one of the one or more flexible membranes and a second flexible membrane (which may be referred to as an outer membrane) such that the second flexible membrane is stacked in a folded state on the first flexible membrane in a folded state. The first membrane and the second membrane may be coupled with each other through one or more hinges coupled with one or more of foam panels coupled with the first membrane and one or more foam panels coupled with the second membrane. In some embodiments, the second flexible membrane is tensioned from a root section of the second flexible membrane to a tip section of the second flexible membrane. For example, the second flexible membrane may be tensioned from the root section, through being coupled with a compression panel, to the tip section, through being coupled with a cross beam of the tip section. In some embodiments, the second membrane may be tensioned through connections between foam panels, such between foam panels coupled with the second membrane and foam panels coupled with the first membrane.

Some embodiments of the system include one or more arm attachments coupled with one or more outer corners of at least the tip section of the second flexible membrane such that one or more wrinkles in the second flexible membrane are reduced. In some embodiments, one or more arm attachments are coupled with one or more outer corners of at least the root section of the second flexible membrane such that one or more wrinkles in the second flexible membrane are reduced. The arm attachment(s) may be referred to as wiper arm outer column attachments that may attach to outer corners of the flexible membrane 110 of an outer column of system 100, which may help reduce wrinkles in the flexible membrane 110. The wiper arm outer column attachment may include a bar or beam portion along with a spreader portion to help reduce wrinkles in outer column flexible membrane 110. This may provide for an even load distribution along the length of the outer column flexible membrane 110.

Some embodiments of the system 100 with multiple bowed battens 140 include one or more snubbers positioned to separate the one or more of the multiple bowed battens 140 from the at least one of the one or more flexible membranes 110. In some embodiments, the one or more snubbers may also separate the one or more torsion springs 170 from the at least one of the one or more flexible membranes.

Some embodiments of the system 100 include one or more latches that control sequential deployment of one or more of the sections from the multiple sections of the at least one or more of the flexible membranes 110. In some embodiments, deployment of a last section of one of the flexible membranes 110 may be controlled by at least one of the one or more latches; other sections may also be controlled through other latches. In some embodiments of the system 100, the one or more flexible membranes 110 are configured to Z-fold. Some embodiments of the system include one or more lanyards that control deployment of the multiple sections of the at least one of the one or more flexible membranes. The one or more lanyards may pass through a variety of components of system 100, such as one or more of the foam panels 120, one or more cross beams, and/or various brackets. Release of the one or more lanyards may be controlled with a motor. With the combinations of structures described herein, system 100 may be described as a system that utilizes a strain energy driven, motor moderated deployment.

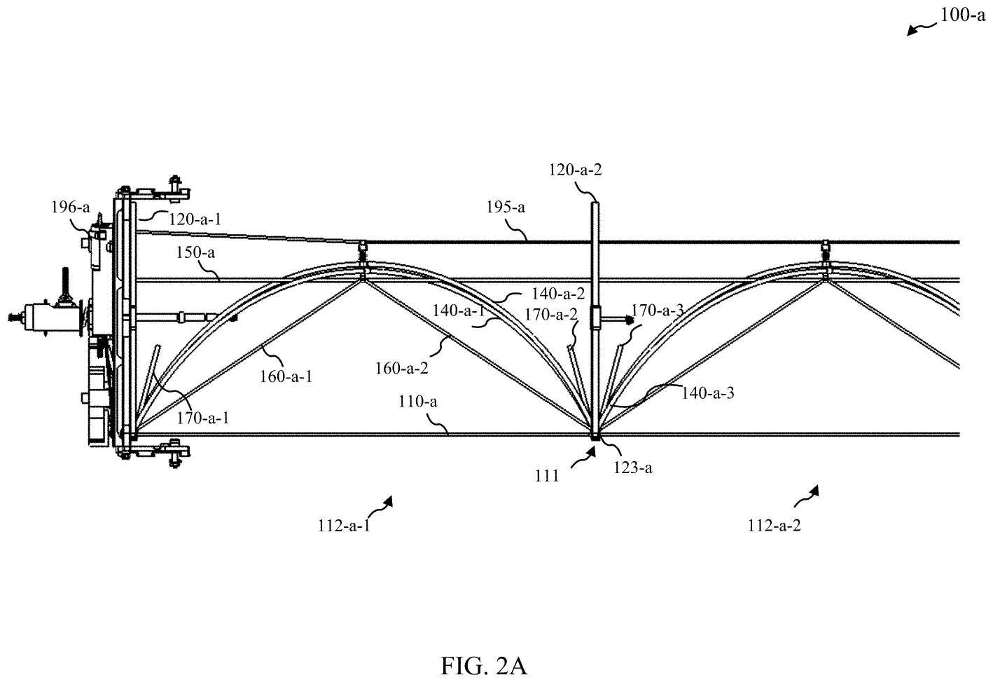

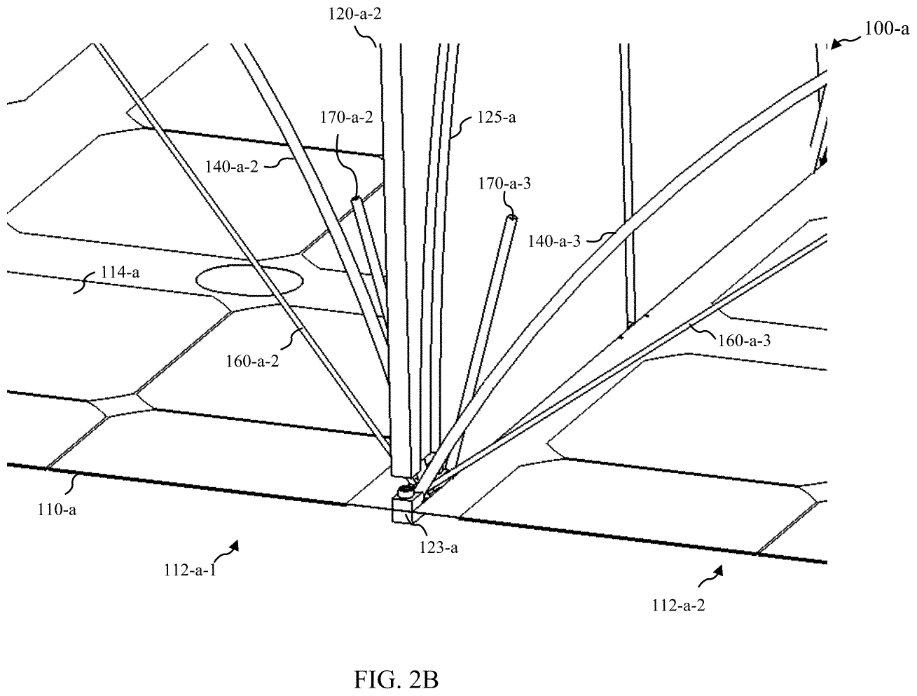

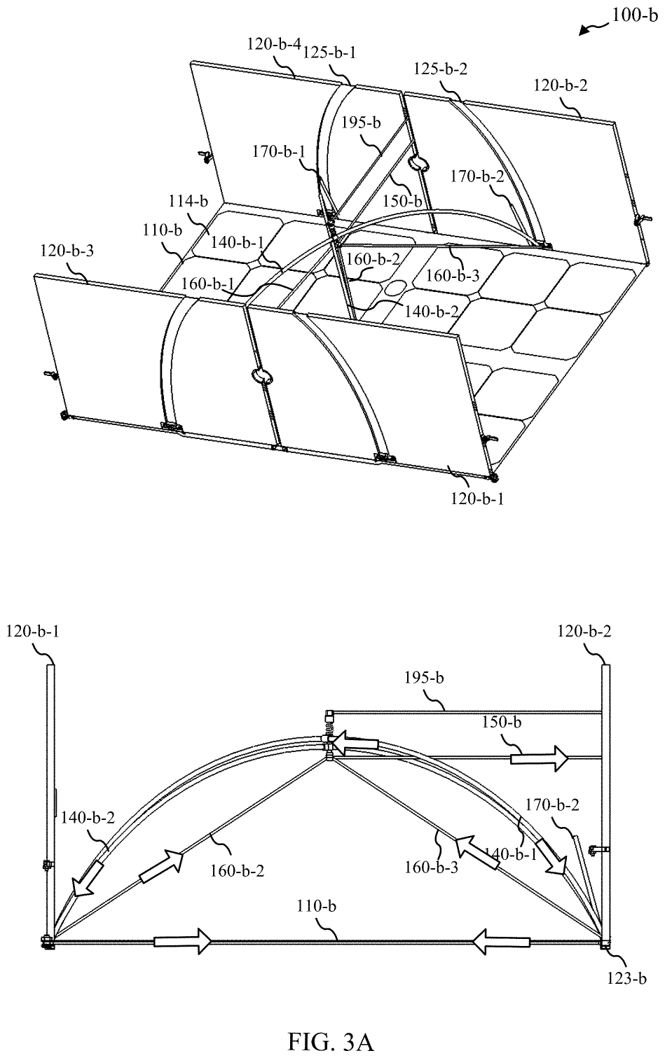

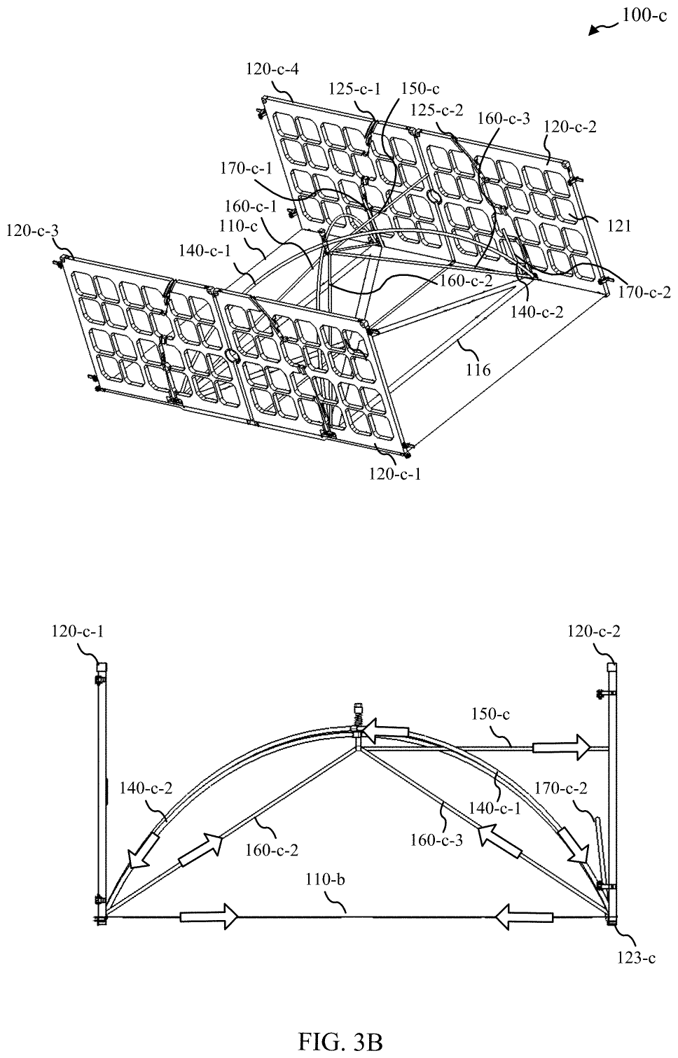

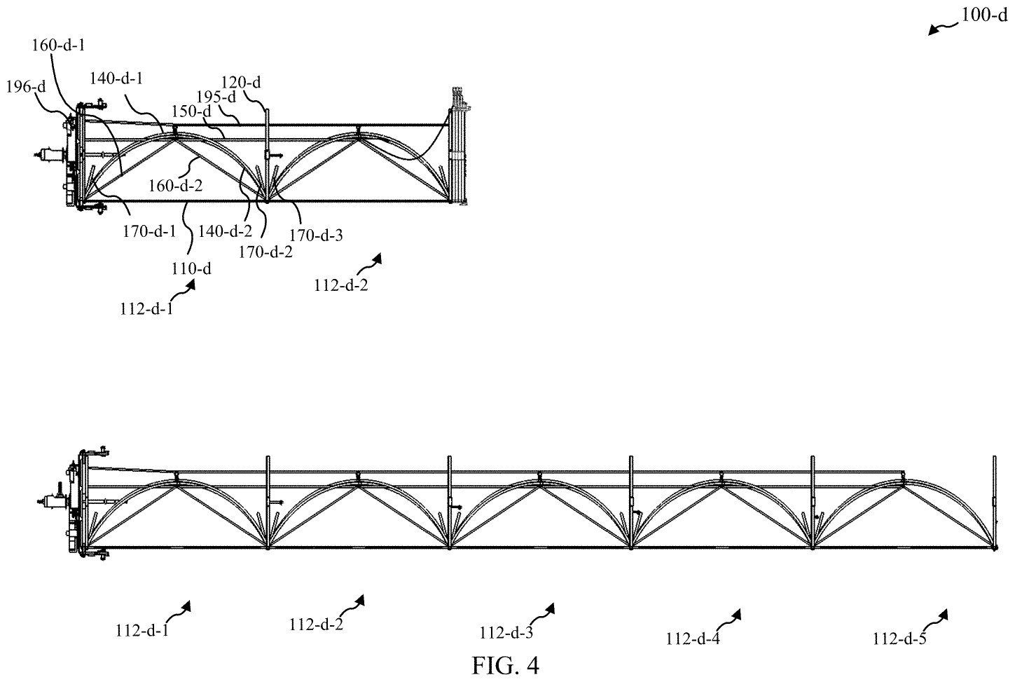

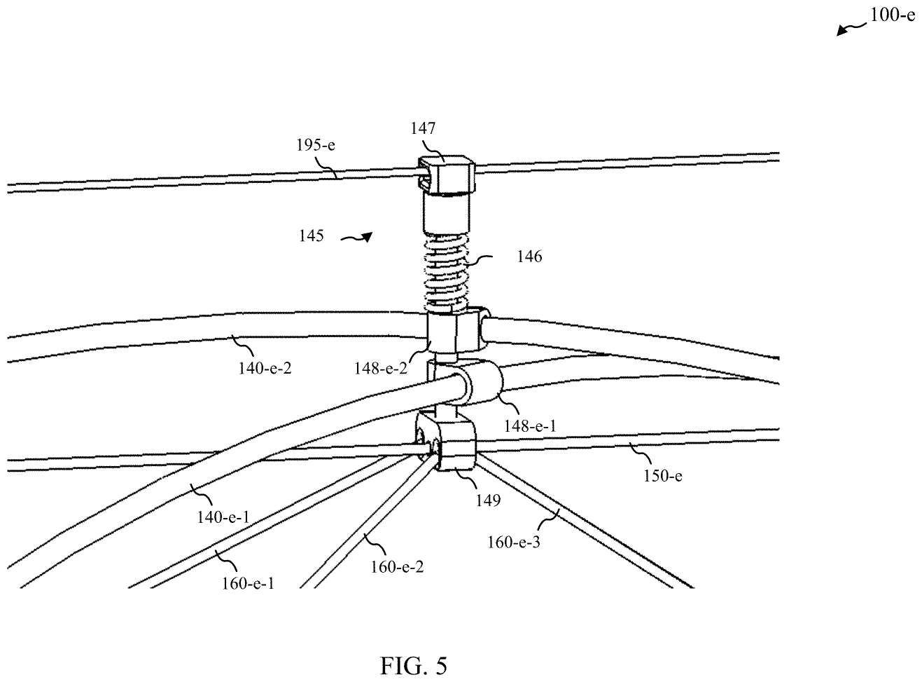

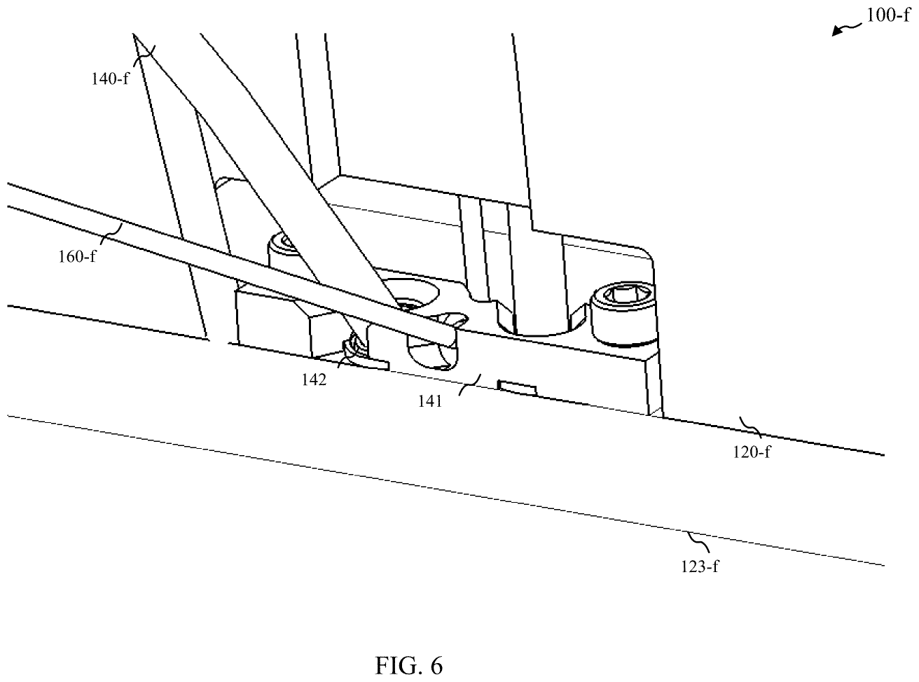

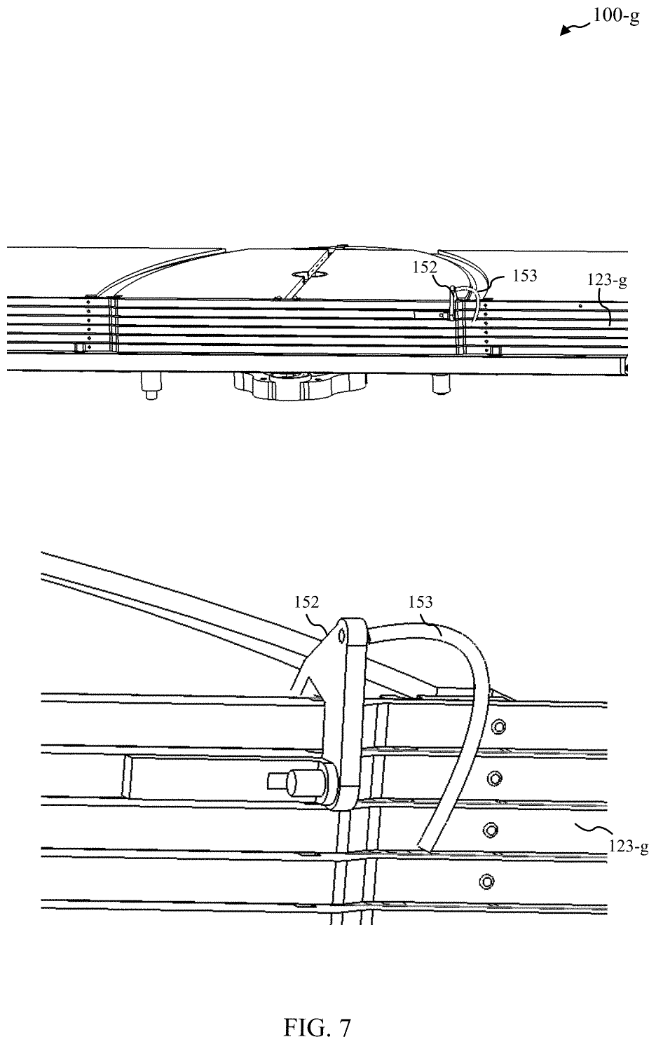

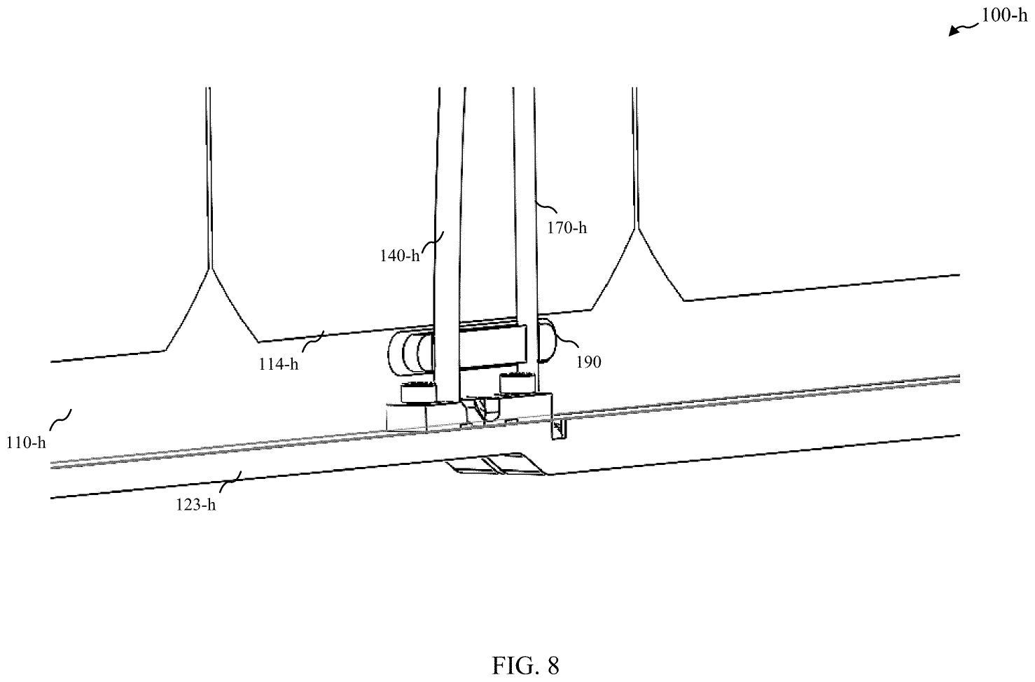

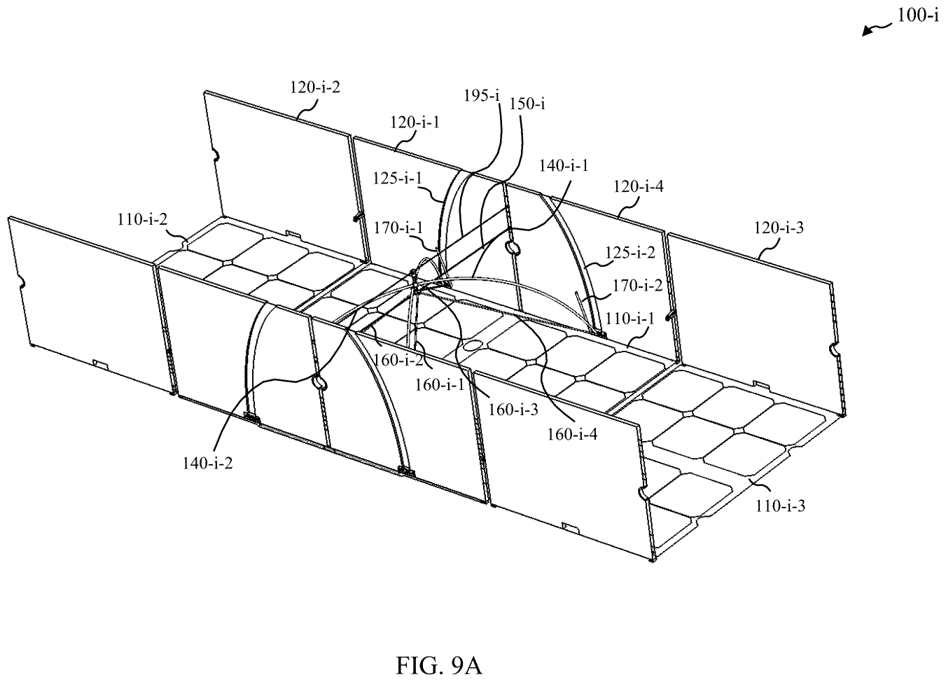

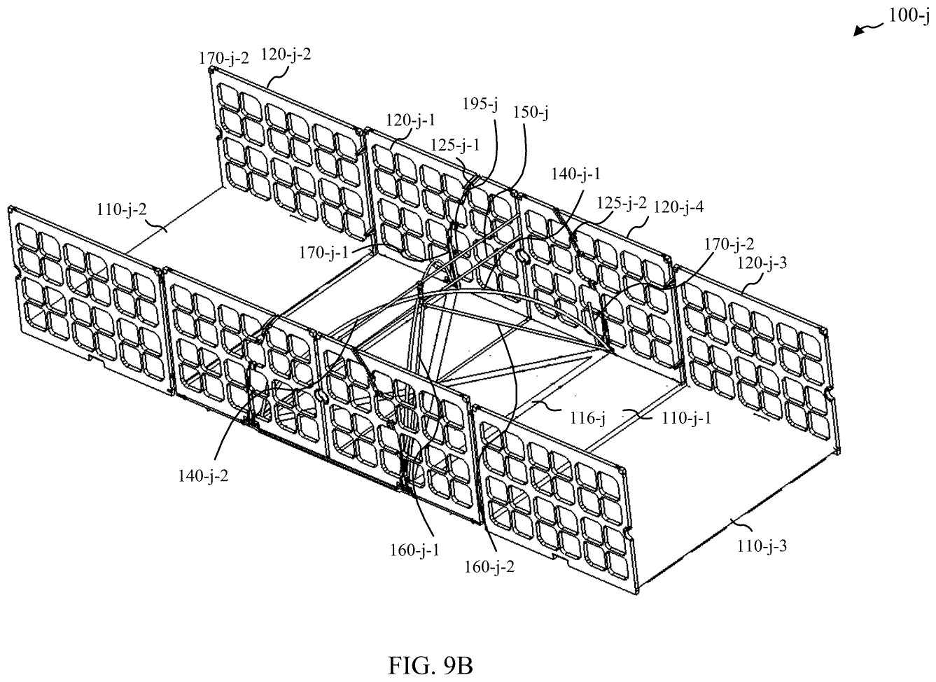

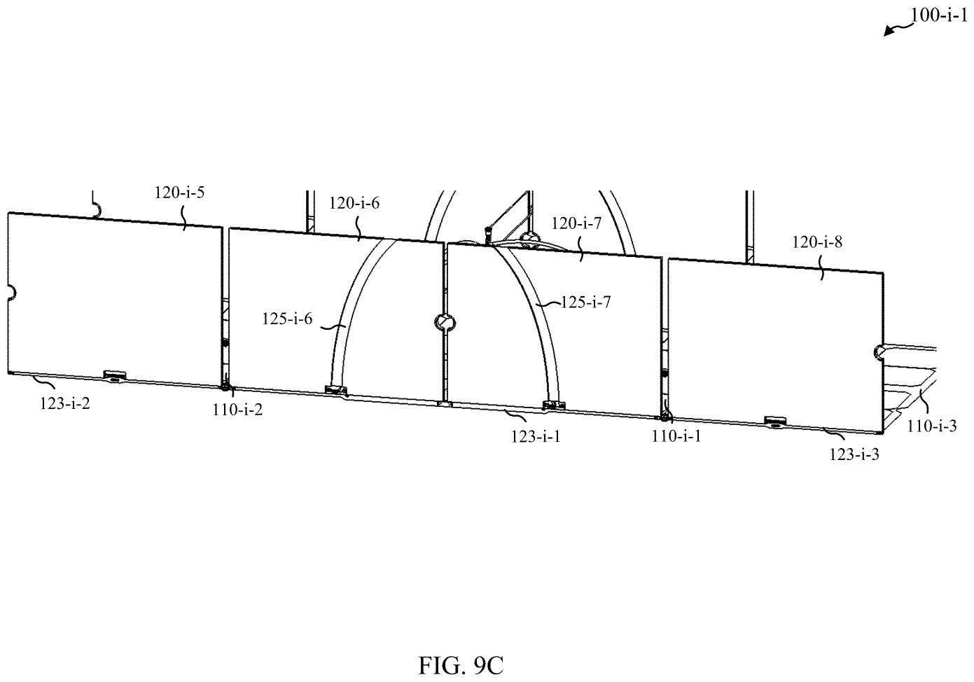

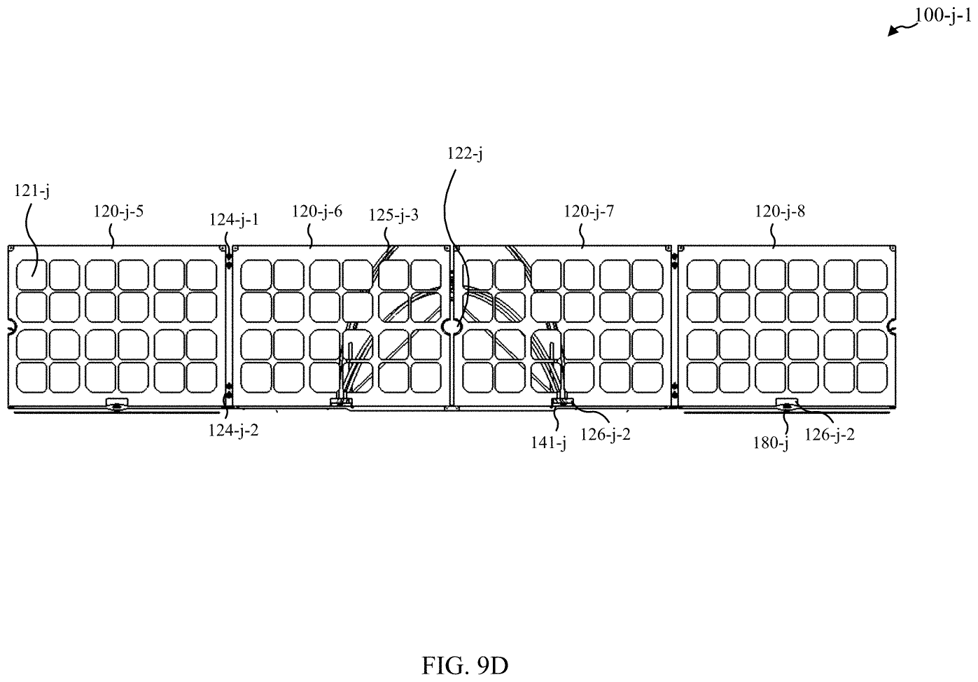

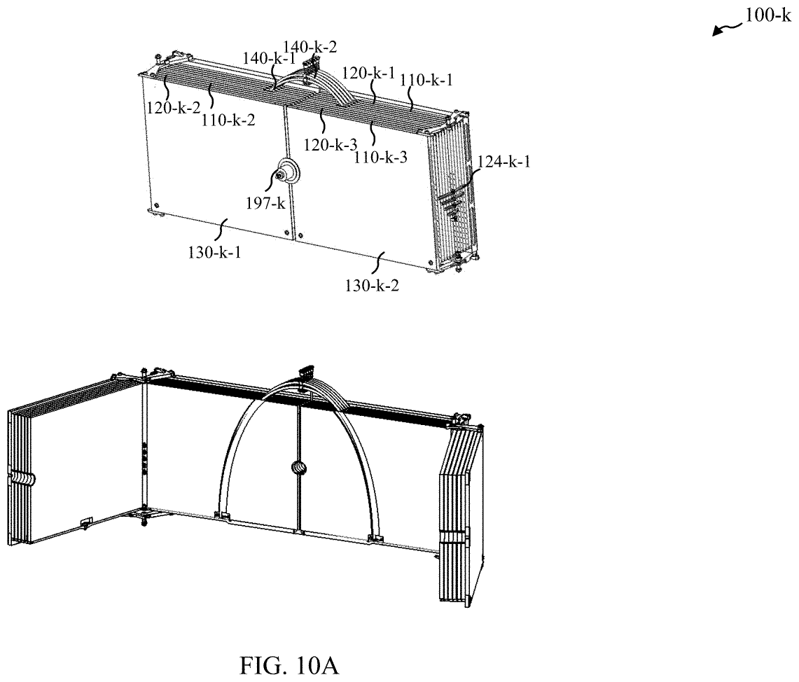

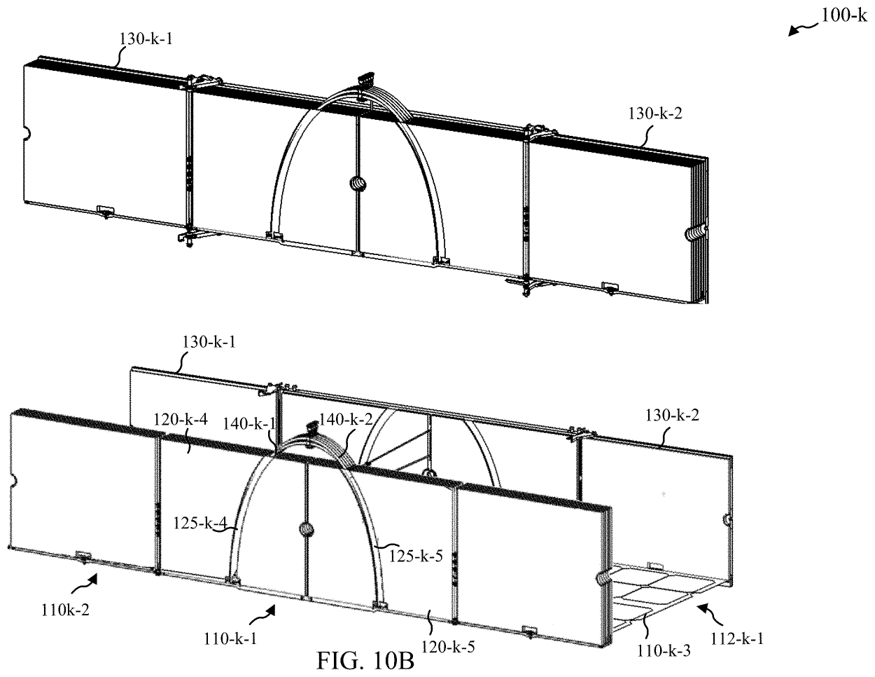

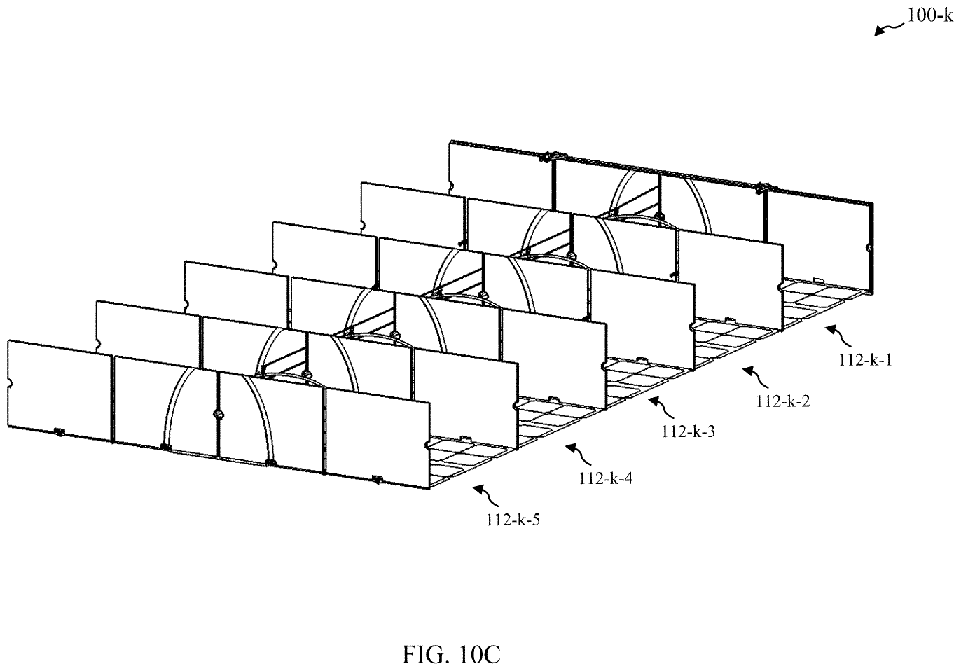

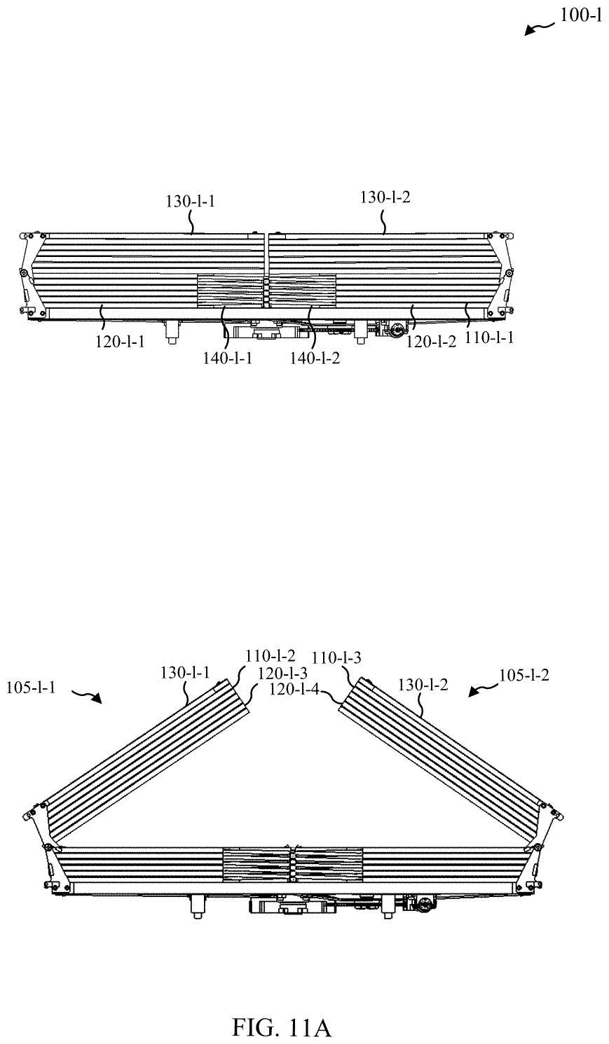

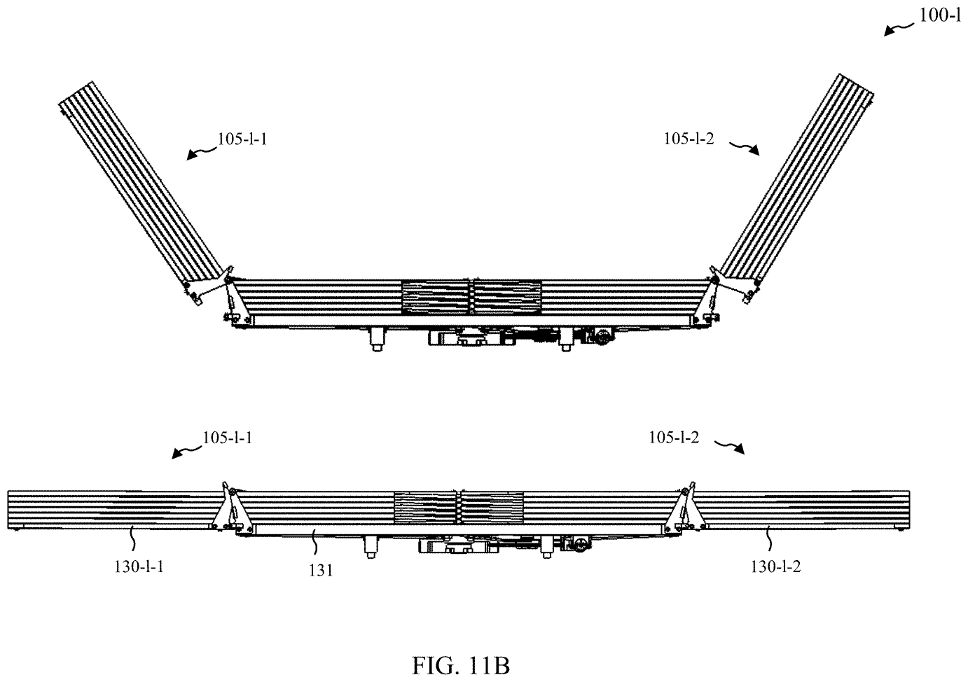

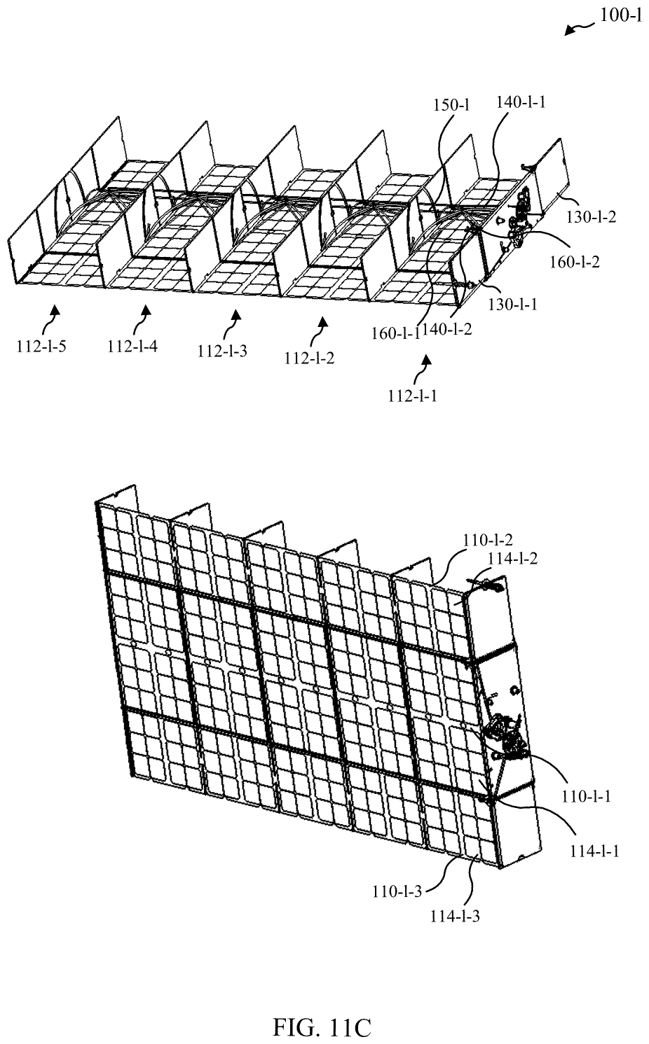

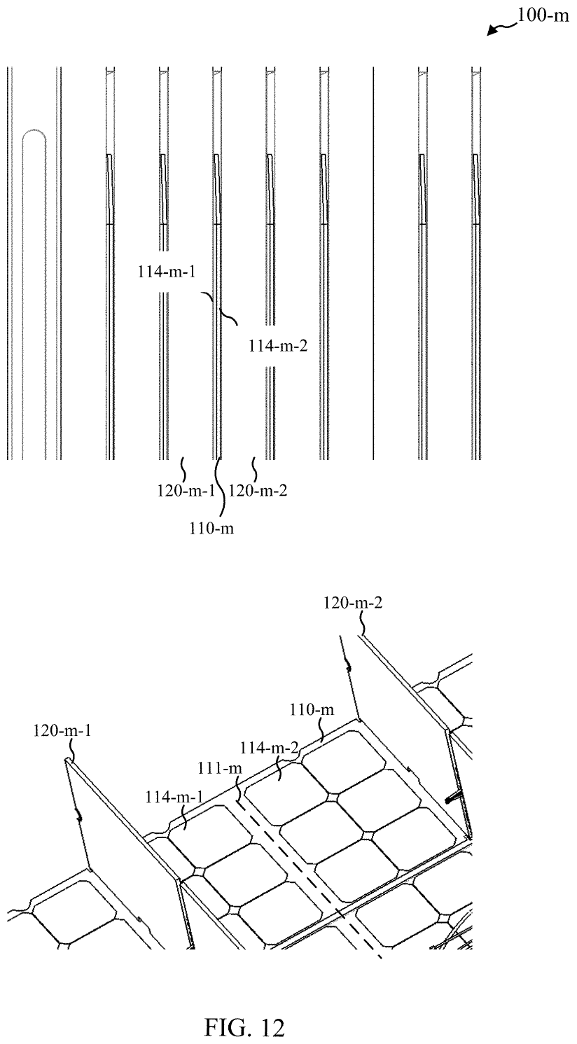

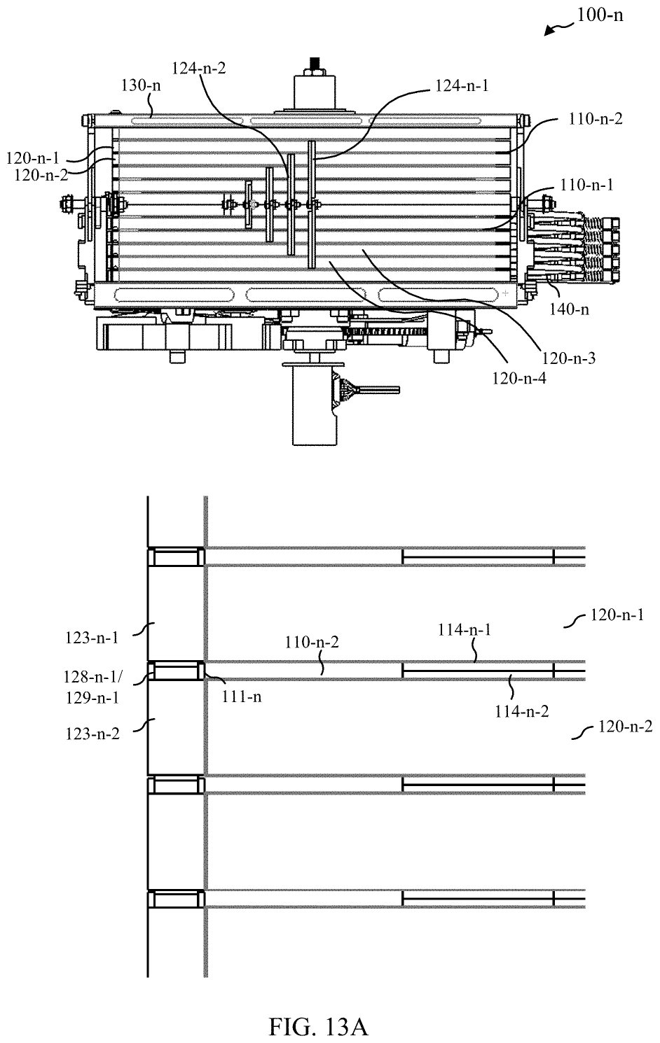

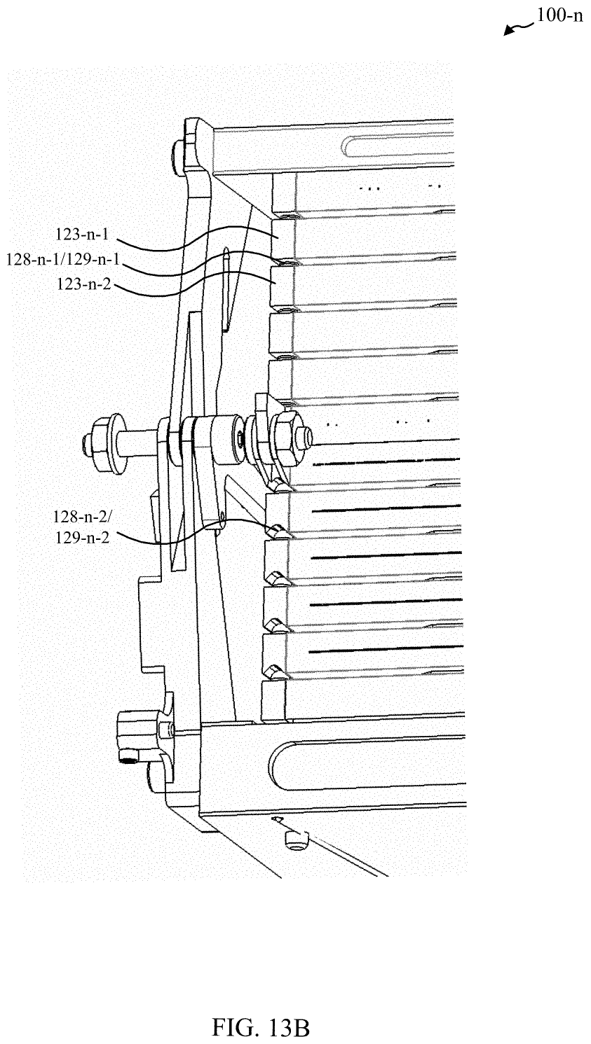

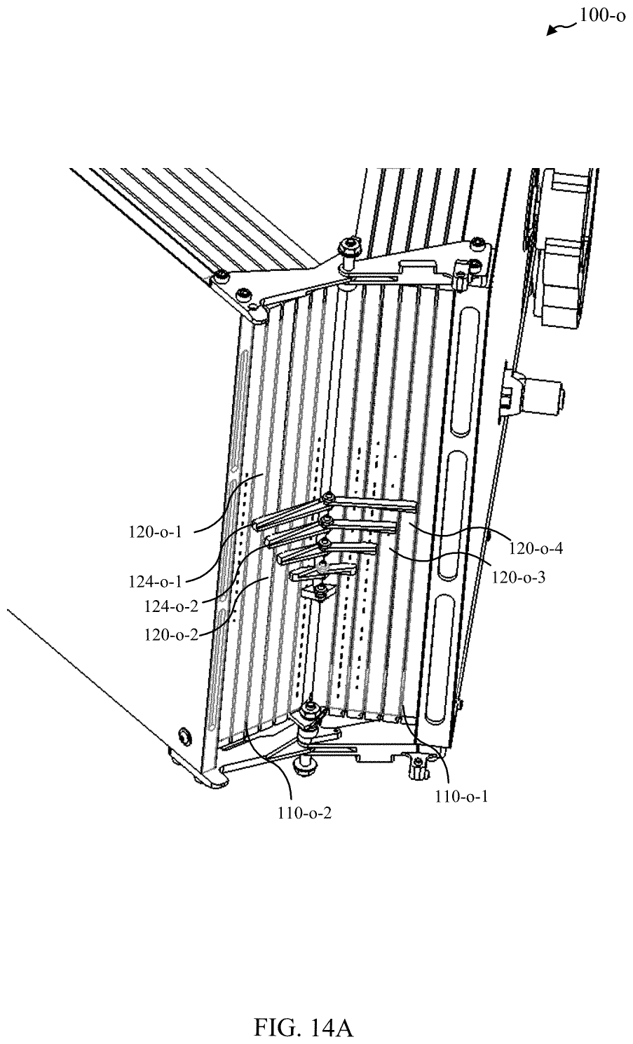

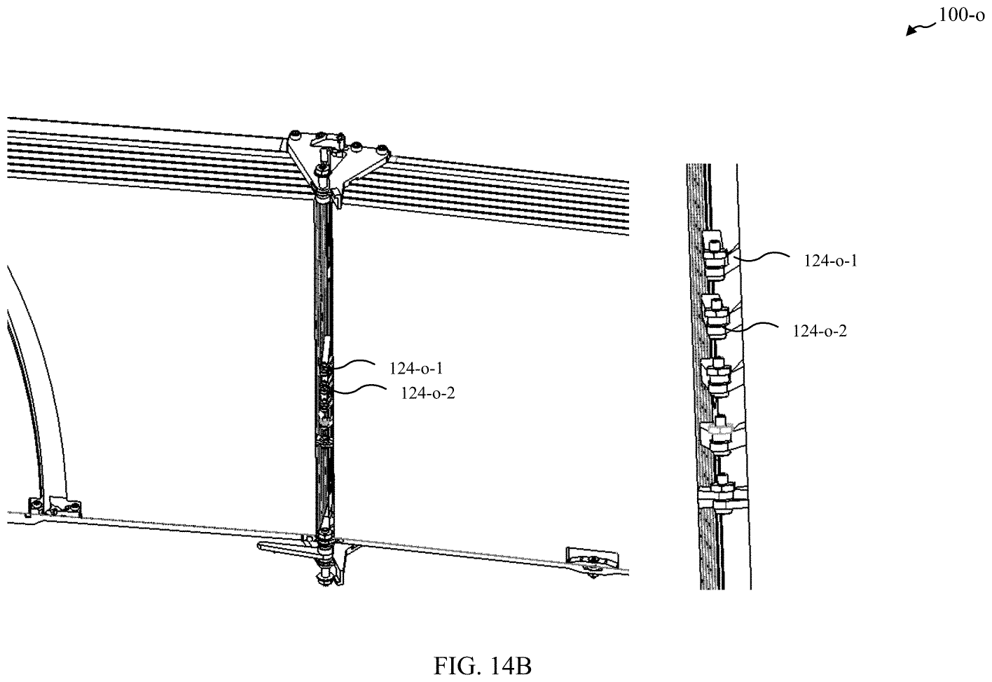

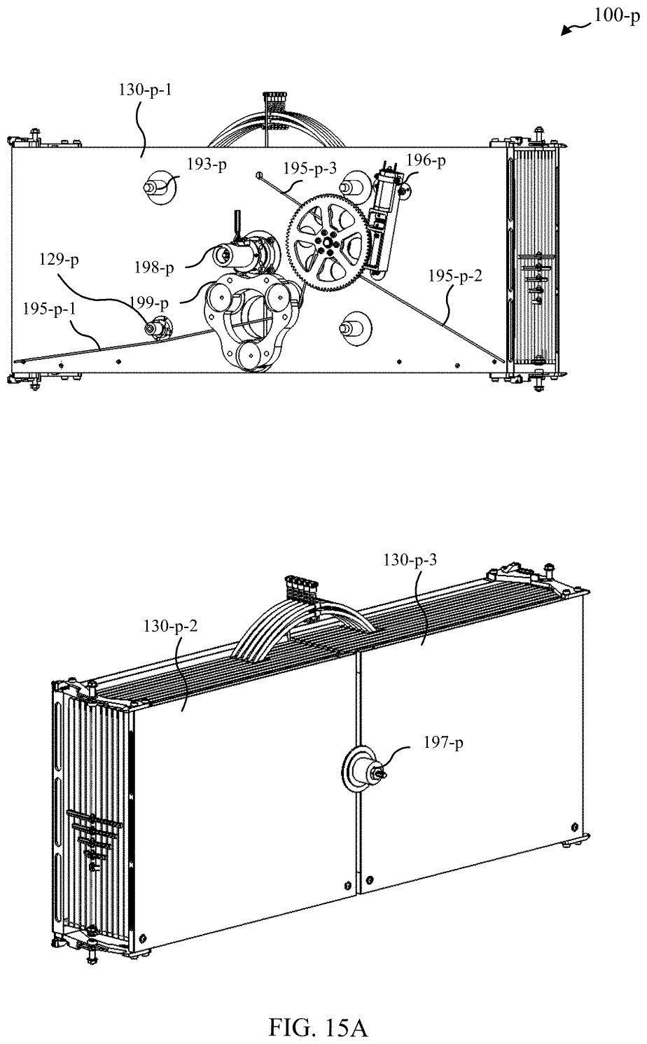

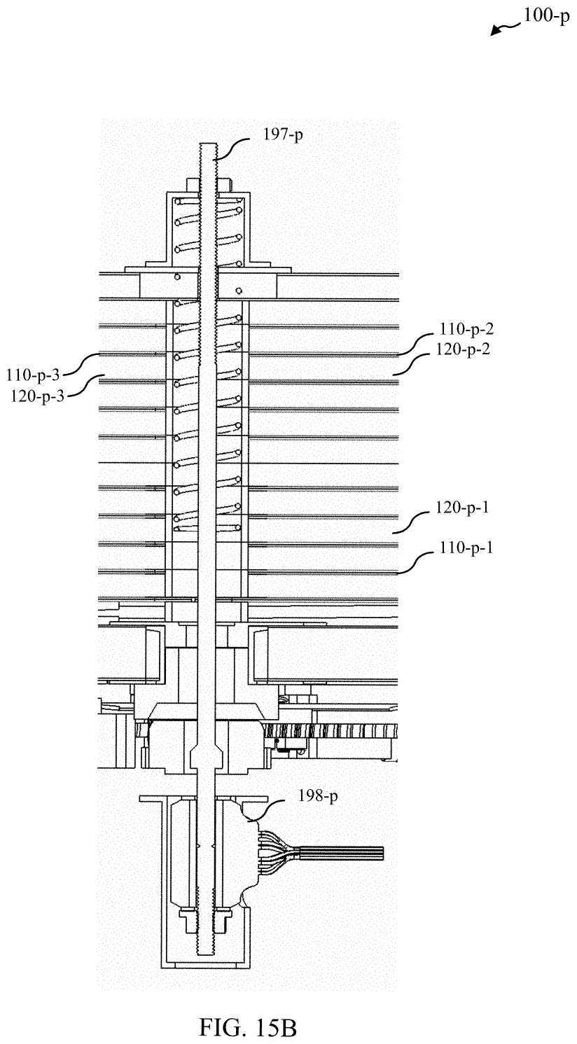

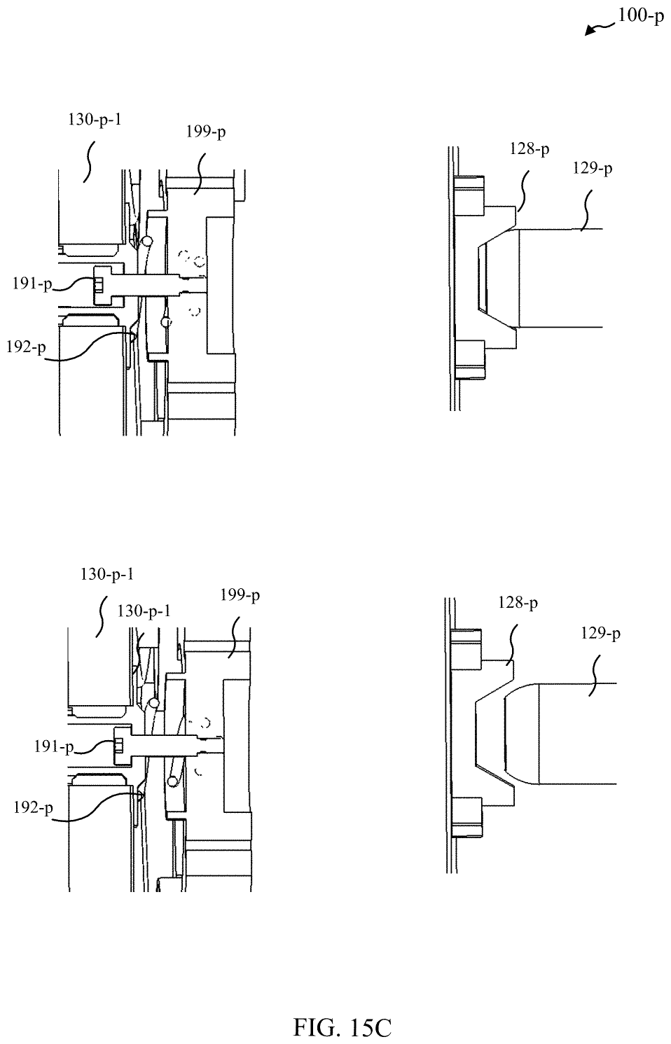

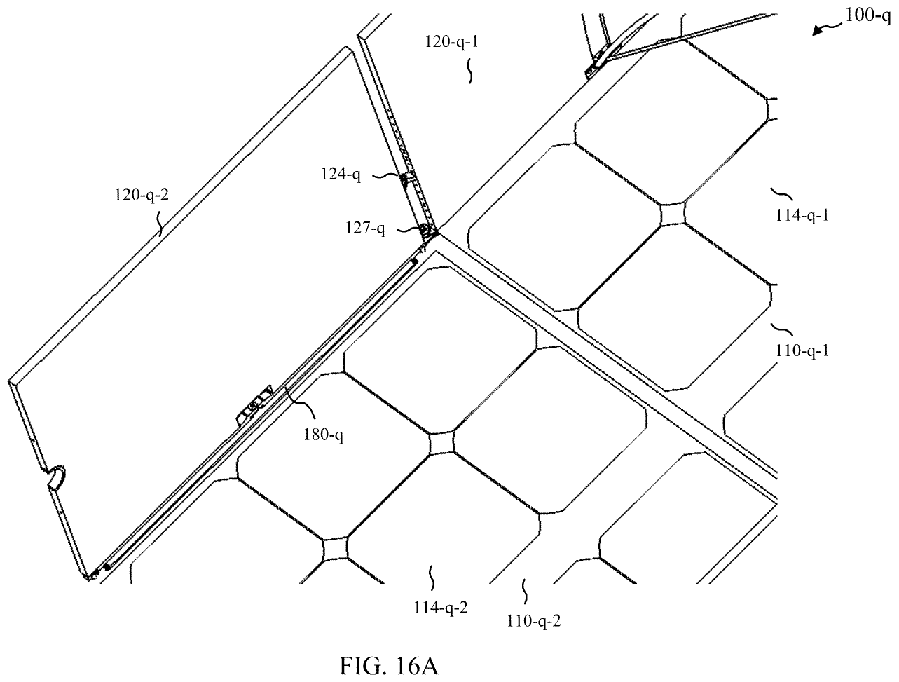

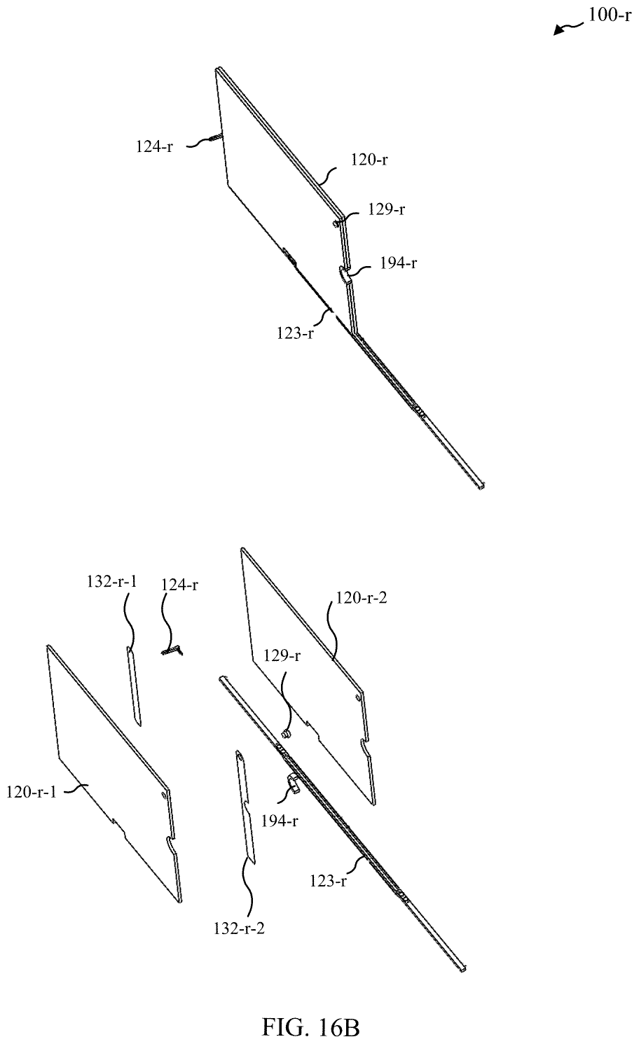

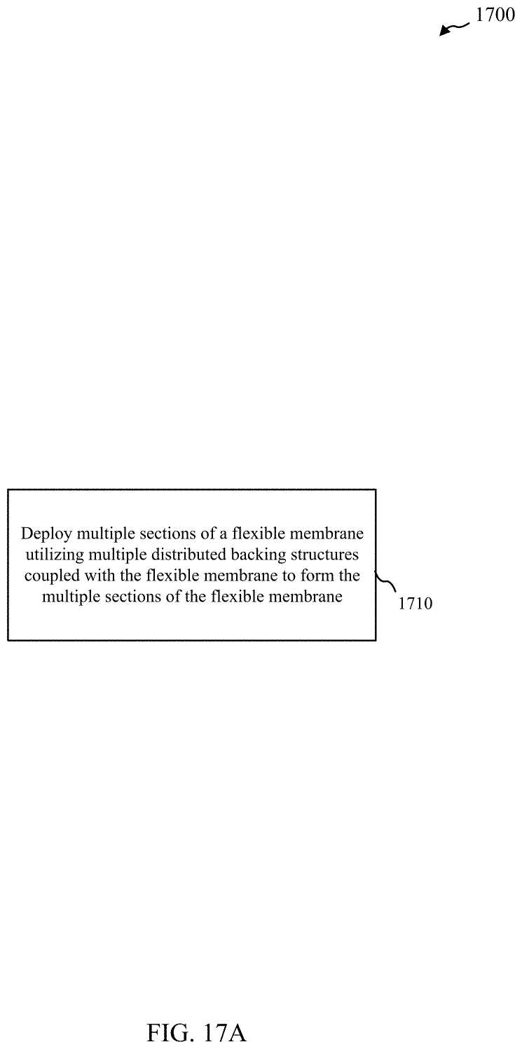

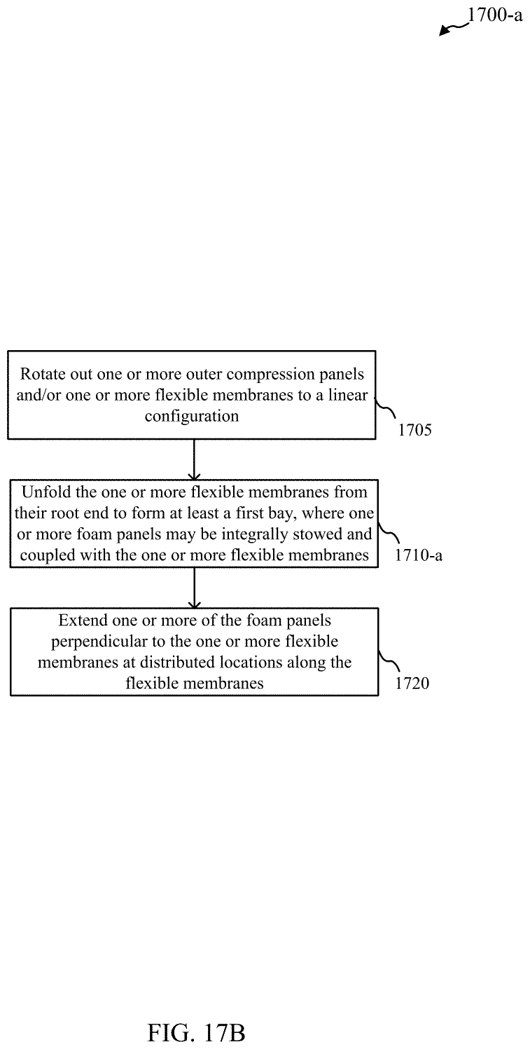

Turning now to FIG. 2A and FIG. 2B, portions of a system 100-a are provided in accordance with various embodiments. System 100-a may be an example of or used in conjunction with aspects of the systems and/or the methods of FIG. 1, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. System 100-a may be referred to as a flexible membrane system. System 100-a may be shown in a deployed or partially deployed state. System 100-a may include a flexible membrane 110-a and multiple distributed backing structures coupled with the flexible membrane 100-a to form multiple sections 112-a-1 and 112-a-2 of flexible membrane 110-a. The multiple sections 112-a-1 and 112-a-2 may define multiple bays of the flexible membrane system 100-a. In some embodiments, flexible membrane 110-a is formed from multiple membrane segments; each membrane segment may be associated with a respective section. Flexible membrane 110-a may include a solar array blanket with multiple photovoltaic cells. Some embodiments of flexible membrane 110-a may include other components, such as RF components. In the following paragraphs, components related to section 112-a-1 are generally called out, though similar components are generally shown with regard to section 112-a-2, though not necessarily called out. With the combinations of structures described in more detail below, system 100-a may be described as a system that is deployed utilizing strain energy while being motor moderated.

System 100-a may include multiple foam panels 120-a-1 and 120-a-2 as part of the multiple distributed backing structures. The multiple foam panels 120-a may be positioned with respect to one or more folds, such as fold 111 for foam panel 120-a-2, of flexible membrane 110-a in a stowed state such that one or more elements (not shown due to side perspective) of flexible membrane 110-a are protected in the stowed state. The one or more elements may include photovoltaic cells, for example. The multiple foam panels 120-a-1 and 120-a-2 may extend perpendicular to flexible membrane 110-a in a deployed state, as generally shown in FIG. 2A.

The multiple distributed backing structures of system 100-a may also include multiple bowed battens, such as bowed battens 140-a-1 and 140-a-2, that apply tension to the flexible membrane 110-a that provide deployment force within section 112-a-1 formed from flexible membrane 110-a. The multiple bowed battens 140-a may include multiple pairs, such as bowed batten 140-a-1 and 140-a-2, where each pair of bowed battens may form a crossed configuration for a respective section, such as section 112-a-1, from the multiple sections of flexible membrane 110-a. Foam panels 120-a-1 and 120-a-2 include one or more channels (not shown due to side perspective) that accommodate portions of bowed battens 140-a-1 and/or 140-a-2 in the stowed state. The multiple distributed backing structures of system 100-a may include one or more torque springs, such as torque springs 170-a-1 and 170-a-2 that generally push the multiple sections, such as sections 112-a-1 and 112-a-2, apart from each other during deployment. Torque springs 170-a-2, for example, may couple with a variety of components within system 100-a, such as bowed batten 140-a-2 and/or foam panel 120-a-2. In some embodiments, foam panel 120-a-2 may have a cross beam 123-a (which may also be referred to as a spreader bar) through which the various components may couple with each other.

The multiple distributed backing structures of system 100-a may include a longeron 150-a that are put under tension from torque springs 170-a-1 and/or 170-a-2 as each section 112-a from the multiple sections deploy. Longeron 150-a may include one or more tensioned cords. The multiple distributed backing structures of system 100-a may include diagonals, such as diagonals 160-a-1 and 160-a-2 that may be tensioned by at least the one or more bowed battens 140-a-1 or 140-a-2 or the one or more torque springs 170-a-1 and 170-a-2 and form a distributed truss structure with longeron 150-a.

The torque springs 170-a-2 and 170-a-3 and may push against the bowed battens 140-a-2 and 140-a-3 and help facilitate pulling on the longeron cord 150-a as it reacts to the battens being pushed aside. As may be shown in the FIG. 2A, the one or more battens 140-a may be included with each section 112-a or bay. Two sets of spring components may facilitate deployment, including the bowed battens 140-a within sections 112-a or bays along with the torque springs 170-a between sections or bays. The cord longeron 150-a may run from section to section (bay to bay). In some embodiments, a pretensioned Kevlar cord may act as the longeron 150-a for each section or bay. Pretension may be achieved by the torque springs 170-a pushing the sections 112-a apart. This configuration may have numerous benefits including adding kick and deployment force, good packaging properties, good deployment kinematics, and/or low parts count.

System 100-a may also include one or more lanyards, such as lanyard 195-a, that may control deployment of the multiple sections 112-a of flexible membrane 110-a. Lanyard 195-a may be one of multiple lanyards that facilitate this control. Lanyard 195-a may be coupled with motor 196-a to control the deployment of the system.

FIG. 2B highlights aspects of system 100-a in accordance with various embodiments. In particular, FIG. 2B highlights portions of system 100-a with respect to sections 112-a-1 and 112-a-2. For example, torque springs 170-a may push against the bowed battens 140-a and help facilitate putting on the longeron 150-a (shown in FIG. 2A) as it reacts to the battens 140-a being pushed aside. Two sets of spring components may facilitate deployment, including the bowed battens 140-a, such as bowed batten 140-a-2 and 140-a-3 within sections, such as section 112-a-1 and 112-a-2, along with the torque springs 170-a, such as torque springs 170-a-2 and 170-a-3, between sections 112-a, such as sections 112-a-1 and 112-a-2. This configuration may have numerous benefits including adding kick and deployment force, good packaging properties, good deployment kinematics, and/or low parts count. FIG. 2B may also show other components not visible in FIG. 2A, such as specific elements (e.g., photovoltaic cells, with one element 114-a specifically called out) of flexible membrane 110-a. Also, foam panel 120-a-2 included one or more channels or cut outs, such as channel 125-a, that may accommodate portions of bowed batten 140-a-3 in the stowed state. Additional components with respect to section 112-a-2 may also be shown, such as diagonal 160-a-3.

Turning now to FIG. 3A and FIG. 3B, a perspective view and a side view of a system 100-b is shown in accordance with various embodiments in FIG. 3A and a variation is shown in system 100-c of FIG. 3B. System 100-b and system 100-c may be examples of or used in conjunction with aspects of the systems and/or the methods of FIG. 1, FIG. 2A, FIG. 2B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. The upper portions of FIG. 3A and FIG. 3B both provide perspective views of a structural column of a single section (or bay) of the flexible membrane or more generally the system 100-b and/or 100-c, respectively. The sections shown in these systems may reflect tip or end sections of a system in particular. For example, the upper portion of FIG. 3A shows system 100-b including multiple bowed battens 140-b-1, 140-b-2, a flexible membrane 110-b, a tensioned longeron 150-b, tensioned diagonals 160-b-1, 160-b-2, and 160-b-3 (a fourth diagonal may be obscured from view), torque springs 170-b-1 and 170-b-2, along with foam panels 120-b-1, 120-b-2, 120-b-3, and 120-b-4 coupled with the flexible membrane 110-b on each side of the section. System 100-b may also show channels 125-b-1 and 125-b-2 that may accommodate portions of bowed battens 140-b-1 and 140-b-2, respectively. Multiple elements, such as photovoltaic elements, of flexible membrane 110-b are also shown, with one element 114-b called out. A lanyard 195-b may also be shown. Similarly, upper portion of FIG. 3B shows system 100-c including multiple bowed battens 140-c-1 and 140-c-2, a flexible membrane 110-c, a tensioned longeron 150-c, tensioned diagonals 160-c-1, 160-c-2, 160-c-3, and a fourth diagonal not specifically called out, torque springs 170-c-1 and 170-c-2, along with foam panels 120-c-1, 120-c-2, 120-c-3, and 120-c-4 coupled with the flexible membrane 110-c on each side of the section. System 100-c may also show channels 125-c-1 and 125-c-2 that may accommodate portions of bowed battens 140-c-1 and 140-c-2, respectively. Multiple elements, such as photovoltaic elements, of flexible membrane 110-c may be included, but are not specifically shown. In addition, a bottom tensioned structure 116 (which may be formed from fiberglass as a truss lattice structure, for example), may be included. The foam panels 120-c-1, 120-c-2, 120-c-3, and 120-c-4 may also have multiple apertures, openings, or lightening holes, which may reduce the weight of the foam panels (one exemplar aperture 121 is called out).

The lower portions of FIG. 3A and FIG. 3B provide side perspectives of system 100-b and system 100-c, respectively. In addition, these figures may highlight the structural load path(s). In general, torque springs 170-b and 170-c may generate moments on the battens 140-b and 140-c, respectively, which may tension the longerons 150-b and 150-c, respectively. The diagonals 160-b and 160-c may be preloaded against the battens 140-b and 140-c, respectively. Compression from the battens 140-b and 140-c may generate tension in the membrane(s) 110-b and 110-c, respectively, and diagonals 160-b and 160-c, respectively.

Systems 100-b and 100-c may include the multiple foam panels 120-b and 120-c, respectively, as part of their multiple distributed backing structures. The multiple foam panels 120-b and 120-c may be positioned with respect to one or more folds of flexible membrane 110-b and 110-c, respectively, in a stowed state such that one or more elements (such as photovoltaic cells 114-b of FIG. 3A, though not explicitly shown in FIG. 3B) of flexible membranes 110-b and 110-c, respectively, are protected in the stowed state. The multiple foam panels 120-b and 120-c may extend perpendicular to flexible membranes 110-b and 110-c, respectively, in a deployed state, as generally shown in FIG. 3A and FIG. 3B.

The multiple distributed backing structures of systems 100-b and 100-c may also include multiple bowed battens, such as bowed battens 140-b and 140-c, that apply tension to the flexible membranes 110-b and 110-c, respectively, that provide deployment force within the shown tip or end sections formed from flexible membranes 110-b and 110-c respectively. The multiple bowed battens 140-b and 140-c may include multiple pairs, as shown in both FIG. 3A and FIG. 3B, where each pair of bowed battens 140-b and 140-c may form a crossed configuration for a respective section from flexible membranes 110-b and 110-c, respectively.

Foam panels 120-b and 120-c may include one or more channels 125-b and 125-c, respectively, that accommodate portions of bowed battens 140-b and 140-c, respectively, in the stowed state. The multiple distributed backing structures of systems 100-b and 100-c may include one or more torque springs 170-b and 170-c, respectively, that generally push the sections of system 100-b and 100-c, respectively, apart from each other during deployment. Torque springs 170-b and 170-c, for example, may couple with a variety of components within systems 100-b and 100-b, respectively, such as bowed battens 140-b and 140-c, respectively, and/or foam panels 120-b and 120-c, respectively. In some embodiments, foam panels 120-b and 120-c may have a cross beams 123-b and 123-c, respectively (which may also be referred to as a spreader bar) through which the various components may couple with each other.

The multiple distributed backing structures of systems 100-b and 100-c may include longerons 150-b and 150-c, respectively, that are put under tension from torque springs 170-b and 170-c, respectively, as these sections from systems 100-b and 100-c deploy. Longerons 150-b and 150-c may include one or more tensioned cords. The multiple distributed backing structures of systems 100-b and 100-c may include diagonals 160-b and 160-c, respectively, that may be tensioned by at least the one or more bowed battens 140-b and 140-c, respectively, or the one or more torque springs 170-b and 170-c, respectively, and form a distributed truss structure with longerons 150-b and 150-c, respectively

FIG. 4 provides a deployment sequence of a system 100-d from partial deployment (upper portion) to full deployment (lower portion) in accordance with various embodiments. System 100-d may be an example of or used in conjunction with aspects of the systems and/or the methods of FIG. 1, FIG. 2A, FIG. 2B, FIG. 3A, FIG. 3B, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. The upper portion of FIG. 4 shows a first section (or bay) 112-d-1 fully deployed with a second section (or bay) 112-d-2 almost fully deployed. The lower portion of FIG. 4 shows five fully deployed sections (or bays) 112-d-1, 112-d-2, 112-d-3, 112-d-4, and 112-d-5. Deployment may be driven by one or more sets of springs (e.g., bowed batten(s) 140-d-1 and 140-d-2 from section or bay 112-d-1) within each section or bay and one or more sets of springs (e.g., torque springs 170-d-1 and 170-d-2 from section or by 112-d-1) between sections or bays. Bowed battens 140-d generally tension components within each section; for example, bowed battens 140-d-1 and 140-d-2 generally tension diagonals 160-d-1 and 160-d-2; torque spring 170-d-2 and 170-d-3 may push sections apart, such as section 112-d-1 and 112-d-2; torque springs 170-d may tension longeron 150-d. In some embodiments, initially large margin torque spring(s) 170-d may kick off section to section (or bay to bay) deployment. As each section or bay deploys, a pair of X configured bowed battens 140-d, such as bowed battens 140-d-1 and 140-d-2 for section 112-d-1, relaxing to a lower strain state may gain more mechanical advantage increasing bay deployment force as deployment continues. In some embodiments, the battens 140-d are unidirectional CFRP and failure of a rod may be graceful with fibers failing, not the entire rod. While components for the first section or bay 112-d-1 are generally called out, similar components are also generally shown for the other sections 112-d-2, 112-d-3, 112-d-4, and/or 112-d-5, though not specifically called out.

A motor driven deployment rate control system may manage deployment force margin. System 100-d, for example, may include one or more motors 196-d coupled with one or more lanyards 195-d to control deployment. Reversing the motor 196-d may retract the array. Deployment order may be controlled by deployment spring force. For example, outer section or bays may have lower force deployment springs. In general, sequencing is passive. Lower or closer to root sections bays may have more deployment force.

FIG. 4 may also show longeron 150-d as it is put under tension during deployment as each section 112-d or bay deploys; in particular, the upper portion of FIG. 4 shows longeron 150-d completely tension with respect to section 112-d-1 though not completely tensioned with respect to section 112-d-2. The one or more torque springs 170-d may push against the foam panels 120-d and/or battens 140-d to facilitate deployment. This may also help tension the longeron 150-d. While a longeron 150-d formed from a tensioned cord may be shown, other embodiments can utilize other forms of longerons, such as battens or foldable components. FIG. 4 may show other components, such as flexible membrane(s) 110-d.

FIG. 5 provides an example of a tension bracket 145 of a system 100-e that may be utilized with respect to the battens 140-e-1 and 140-e-2, diagonals 160-e-1, 160-e-2, and 160-3 (a fourth diagonal may be obscured from view), longeron 150-e, and lanyard 195-e. System 100-e may be an example of or used in conjunction with aspects of the systems and/or the methods of FIG. 1, FIG. 2A, FIG. 2B, FIG. 3A, FIG. 3B, FIG. 4, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. The tension bracket 145 may have various components such as preload spring 146, lanyard bracket 147, batten brackets 148-e-1 and 148-e-2, and diagonal/longeron bracket 149.

FIG. 6 shows aspects of a system 100-f in accordance with various embodiments, in particular showing a batten retaining plate 141. System 100-f may be an example of or used in conjunction with aspects of the systems and/or the methods of FIG. 1, FIG. 2A, FIG. 2B, FIG. 3A, FIG. 3B, FIG. 4, FIG. 5, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. The batten retaining plate 141 may hold various components, such as the battens 140-f, batten end spheres 142, and diagonal 160-f. Batten retaining plate 141 may be coupled with cross beam 123-f. Foam panel 120-f may also be shown.

FIG. 7 shows aspects of a system 100-g in accordance with various embodiments, in particular showing a latch 152 and tether 153. System 100-g may be an example of or used in conjunction with aspects of the systems and/or the methods of FIG. 1, FIG. 2A, FIG. 2B, FIG. 3A, FIG. 3B, FIG. 4, FIG. 5, FIG. 6, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. The latch 152 may help control the sequential deployment of one or more sections of the flexible membrane (obscured from view in this stowed state) of system 100-g. The upper portion of FIG. 7 shows the system 100-g in a stowed state. The lower portion highlights the latch 152 and tether 153. In this example, the latch 152 may control deployment of a tip section of the flexible membrane. The tether 153 coupled with latch 152 may be coupled with aspects of the penultimate section, such as a cross beam 123-g or other component of the penultimate section such that when the penultimate section has fully deployed, the tether 153 pulls on latch 152 to release the tip or final section for deployment. This configuration of latch and tether may also be utilized with respect to other sections or bays of the system to control deployment of specific sections or bays.

FIG. 8 shows aspects of a system 100-h in accordance with various embodiments, in particular showing a snubber 190. System 100-h may be an example of or used in conjunction with aspects of the systems and/or the methods of FIG. 1, FIG. 2A, FIG. 2B, FIG. 3A, FIG. 3B, FIG. 4, FIG. 5, FIG. 6, FIG. 7, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. Snubber 190 may be positioned to separate the bowed batten 140-h and/or torque spring 170-h from flexible membrane 110-h and/or element 114-h of flexible membrane 110-h. This may further provide protection to element 114-h (such as photovoltaic cells) and/or other aspects of flexible membrane 110-h such as during stowage of the system 100-h. Cross beam 123-h may also be shown.

FIG. 9A and FIG. 9B show aspect of a single bay of a system 100-i and another single bay of a system 100-j in accordance with various embodiments. Systems 100-i and 100-j may be examples of or used in conjunction with aspects of the systems and/or the methods of FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. Systems 100-i and 100-j each include multiple membranes, including flexible membranes 110-i-1, 110-i-2, and 110-i-3 of system 100-i and flexible membranes 110-j-1, 110-j-2, and 110-j-3 of system 100-j. Each of these systems may thus include two outer tensioned column sections or bays, which may include flexible membranes 110-i-2 and 110-i-3 (or 110-j-2 and 110-j-3) and their associated foam panels, including foam panels 120-i-2 and 120-i-3 (or 120-j-2 and 110-j-3). and one center structural column section or bay, which flexible membrane 110-i-1 (or flexible membrane 110-j-1) and their various distributed backing structures. For example, the center structural column section or bay of system 100-i may include foam panels 120-i, such as foam panels 120-i-1 and 120-i-4, bowed battens 140-i, such as bowed battens 140-i-1 and 140-i-2, longerons 150-i, diagonals 160-i, such as diagonals 160-i-1, 160-i-2, 160-i-3, and 160-i-4, lanyard 195-i, and torque springs 170-i, such as torque springs 170-i-1 and 170-i-2. Foam panels 120-i-1 and 120-i-4 may also include channels or cut out portions 125-i-1 and 125-i-2, respectively, that may accommodate battens 140-i-1 and 140-i-2. Similarly, the center structural column section or bay of system 100-j may include foam panels 120-j, such as foam panels 120-j-1 and 120-j-4, bowed battens 140-j, such as bowed battens 140-j-1 and 140-j-2, longerons 150-j, diagonals 160-j, such as diagonals 160-j-1, and 160-j-2 (two other diagonals that may be obscured from view), lanyard 195-j, and torque springs 170-j, such as torsion springs 170-j-1 and 170-j-2. Foam panels 120-j-1 and 120-j-4 may also include channels or cut out portions 125-j-1 and 125-j-2, respectively, that may accommodate battens 140-j-1 and 140-j-2. System 100-j may also include a truss lattice structure 116-j coupled with flexible membrane 110-j-1.

With the use of multiple flexible membranes, systems 100-i and 100-j may be configured such that the components may be folded together for stowage and then deployed as described in more detail below. FIG. 9C provides a variation of system 100-i as system 100-i-1, which may be configured as a tip section of the system. System 100-i-1 highlights several components, such as beam structures 123 of a system 100-i that may facilitate coupling the foam panels 120-i-5, 120-i-6, 120-i-7, and 120-i-8 with the flexible membranes 110-i-1, 110-i-2, and 110-i-3. For example, beams 123-i-1, 123-i-2, and 123-i-3 may be referred to as cross beams. Two outer beams 123-i-2 and 123-i-3 and a center beam 123-i-1 are highlighted. The cross beams 123-i may serve as lateral structural elements and fastening members for section or bay components. The outer beams may be single column widths and may fold out to tension the outer columns. Cross beams may generally be utilized for intermediate bays. In some embodiments, spreader bars are utilized as the beams 123-i. A variety of components may be shown, such as flexible membrane(s) 110-i and foam panel(s) 120-i; other components may be shown, but not called out. Channels 125-i-5 and 125-i-6 may also be shown with respect to foam panels 120-i-6 and 120-i-7. FIG. 9D provides a variation of system 100-j as system 100-j-1, which may be configured as a tip section of the system. System 100-j-1 generally highlights aspects of the foam panels 120-j-5, 120-j-6, 120-j-7, and 120-j-8 in accordance with various embodiments. This example shows foam panels 110-j with lightening holes, such as lightening hole or aperture 121-j, around the cell center, though some embodiments do not utilize lightening holes. A launch restrain pass through 122-j may be shown along with foam panel hinges 124-j, such as hinges 124-j-1 and 124-j-2, between the foam panels. The foam panel hinges 124-j may provide for stiffness, tension, and/or alignment for the outer columns in particular. FIG. 9D also shows example of channels 125-j-3 that may be formed in one or more of the foam panels; these channels may accommodate components such as the stowed battens and may help protect aspects of the flexible membranes, such as solar cells or other delicate components. Some cuts outs 126-j-1 and 126-j-2 also may be shown that may accommodate a batten retaining plate 141-j and/or an arm attachment 180-j.

FIG. 10A, FIG. 10B, and FIG. 10C show a deployment sequence for a system 100-k in accordance with various embodiments. System 100-k may be an example of or used in conjunction with aspects of the systems and/or the methods of FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. System 100-k in particular may show a deployment sequence based on a multi-membrane system similar to those shown in FIG. 9A and/or FIG. 9C but with additional sections or bays shown.

FIG. 10A shows a stowed state in the upper portion, which may include outer compression panels 130-k-1 and 130-k-2 that may compress the interleaved flexible membranes 110-k-1 (as a central membrane), 110-k-2 (as an outer membrane), and 110-k-3 (as another outer membrane) with respect to the multiple distributed backing structures, such as foam panel(s), batten(s), torque spring(s), diagonal(s), and/or longeron(s). Foam panels 120-k-1, 120-k-2, and 120-k-3 along with bowed battens 140-k-1 and 140-k-2 are specifically called out in FIG. 10A; torque spring(s), diagonal(s), and longeron(s) may be obscured from view. A hold down release mechanism (HDRM) may be utilized that may include a single Frangibolt 197-k. The HDRM may release the system to allow for deployment.

In the upper portion of FIG. 10A, flexible membranes 110-k-2 and 110-k-3 may be stacked in folded states on flexible membrane 110-k-1, which may also be in a folded state. Flexible membranes 110-k-2 and 110-k-3 may be coupled with flexible membrane 110-k-1 through one or more hinges coupled with one or more of foam panels coupled with the flexible membrane 110-k-2 and one or more foam panels coupled with flexible membrane 110-k-1 (similarly, one or more foam panels coupled with flexible membrane 110-k-3 and one or more foam panels coupled with flexible membrane 110-k-1). For example, foam panel 120-k-1 coupled with flexible membrane 110-k-1 may be coupled with foam panel 120-k-3 coupled with flexible membrane 110-k-3 utilizing hinge 124-k-1 or one of the other hinges shown.

The two outer membranes 110-k-2 and 110-k-3 along with their foam panels 120-k-2 and 120-k-3 along with the compression panels 130-k-1 and 130-k-2 may rotate out in the lower portion of FIG. 10A. These portions of system 110-k may be referred to as outer columns. The upper portion of FIG. 10B shows a linear configuration before the root sections or bays 112-k-1 begin deployment in the lower portion of FIG. 10B. FIG. 10B generally shows that the compression panels 130-k-1 and 130-k-2 remain at a root of the flexible membrane system during the deployment after they have unfolded. Bowed battens, such bowed battens 140-k-1 and 140-k-2, may be accommodated by channels, such as channels 125-k-4 and 125-k-5 in one or more of the foam panels, such as foam panels 120-k-4 and 120-k-5. The bowed battens may be shown extending out from the stowed configurations. As system 100-k proceeds to deploy from the linear configuration in the upper portion of FIG. 10B, the multiple foam panels 120-k generally extend perpendicular to the flexible membranes 110-k-1, 110-k-2, and 110-k-3 as the sections of each of these membranes deploys as shown in the lower portion of FIG. 10B, resulting in the final deployed configuration as shown in FIG. 10C, showing five deployed sections or bays 112-k-1, 112-k-2, 112-k-3, 112-k-4, and 112-k-4.

Turning now to FIG. 11A, FIG. 11B, and FIG. 11C, a deployment sequence of a system 100-l is shown in accordance with various embodiments. System 100-l may be an example of or used in conjunction with aspects of the systems and/or the methods of FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. FIG. 11A and FIG. 11B in general provide side views of the initial deployment of system 100-l before sections or bays are deployed.

System 100-l may generally utilize a distributed backing support system for one or more flexible membranes, such as with respect to flexible membrane 110-l-1, that may be interleaved or intermingled with the folded membrane 110-l-1 or blanket stack as generally shown. The distributed backing structure(s) may attach along multiple points of the blanket(s) rather than just at the root and the tip of flexible membrane 110-l-1. For example, there may be multiple pickup points that each section or bay may be picked up. System 100-l may show a variety of components that may be described here or elsewhere in the application, such as compression panel(s) 130-l-1 and 130-l-2, foam panel 120-l (with panels 120-l-1 and 120-l-2 specifically called out, bowed battens 140-l (including bowed battens 140-l-1 and 140-l-2 specifically called out, longeron 150-l, and/or diagonal 160-l (including diagonals 160-l-1 and 160-l-2 specifically called out; other components may be shown).

System 100-l shows an example where outer membranes and their associated panels may rotate about their outboard edges. The two outboard column membrane assemblies 105-l-1 and 105-l-2, for example, may rotate 180 degrees to the left and right as may be shown in the bottom of FIG. 11A. These outer column assemblies 105-l-1 and 105-l-2 may include folded flexible membranes 110-l-2 and 110-l-3 and respective foam panels 120-l (such as foam panels 120-l-3 and 120-l-4 specifically called out). In some embodiments, the entire array moves away from a bus. The use of tri-folded membrane assemblies may eliminate a tip honeycomb panel. The moment of inertia of the solar array may be reduced. In addition, the mass of the solar array end spreader bar may be reduced. Top and bottom launch restraint panels, such as compression panels 130-l-1 and 130-l-2 and bottom panel 131, may act as base spreaders when unfolded. Torque springs may rotate the outboard membrane and panel stacks to a flat configuration.

In general, after the linear deployment shown in bottom of FIG. 11B, sections or bays may deploy from the root first as shown in the right-hand image. A rate control motor may reel out one or more lanyards to allow the array to deploy. Sequencing may be due to the root most bays each having larger deployment forces. FIG. 11C shows in particular system 100-l in a deployed state with multiple flexible membranes 110-l, including central membrane 110-l-1 coupled with multiple distributed backing structures along with two outer tensioned column structures that include flexible membranes 110-l-2 and 110-l-3. System 100-l also highlights the use of multiple foam panels 120-l that make contact with the flexible membranes 110-l at different distributed locations along their backsides. A central longeron 150-l may also be seen. Bowed battens 140-l and/or diagonals 160-l may also be shown with respect to each bay with respect to the central membrane 110-l-1. The deployed configuration shown in FIG. 11C includes five deployed sections or bays 112-l-1, 112-l-2, 112-l-3, 112-l-4, and 112-l-5. Each flexible membrane 110-l-1, 110-l-2, and 110-l-3 may also include multiple elements, such as photovoltaic cells 114-l-1, 114-l-2, and 114-l-3.

FIG. 12 shows aspects of a system 100-m in accordance with various embodiments. System 100-m may be an example of or used in conjunction with aspects of the systems and/or the methods of FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. FIG. 12 may show aspects of a stowed orientation in the upper portion, where elements, such as solar cells, may face each other with foam panels 120-m-1 and 120-m-2 on each side of the folded flexible membrane 110-m. A fold line 111-m for the flexible membrane 110-m may also be shown for the deployed state, with the elements 114-m-1 and 114-m-2 that face each other in the stowed state now shown on opposite sides from the fold line 111-m. Foam panels 120-m-1 and 120-m-2 may be positioned with respect to fold 111-m of flexible membrane 110-m in the stowed state such that elements 114-m-1 and 114-m-2, for example, of flexible membrane 110-m are protected in the stowed state.

FIG. 13A and FIG. 13B show aspects of a system 100-n in accordance with various embodiments. System 100-n may be an example of or used in conjunction with aspects of the systems and/or the methods of FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 14A, FIG. 14B, FIG. 15A, FIG. 15B, FIG. 15C, FIG. 16A, FIG. 16B, FIG. 17A, and/or FIG. 17B. System 100-n may show a compressed, stowed stack configuration along with a highlighted portion on the lower portion of FIG. 13A and the main portion of FIG. 13B. A variety of system components that are called out, such as foam panels 120-n-1, 120-n-2, 120-n-3 and 120-n-4, panel hinges 124-n-1 and 124-n-2, cross beams 123-n-1 and 123-n-2, flexible membranes 110-n-1 and 110-n-2, elements 114-n-1 and 114-n-2, a stack of bowed battens, including bowed batten 140-n, and cup 128-n-1/cone 129-n-1 and 128-n-2/129-n-2 structures. FIG. 13B may show aspects of cross beam cup cone stacks 128-n-1/129-n-1 and 128-n-2/129-n-2. For example, two cup cone stacks on each outer beam, such as cross beams 123-n-1 and 123-n-2, may keep sections or bays aligned and may prevent herniating.

System 100-n may also show one or more compression panels, such as compression panel 130-n that compress flexible membranes 110-n-1 and 110-n-2 and other backing structures (such as foam panels 120-n-1, 120-n-2, 120-n-3, and 120-n-4 and bowed battens, such as bowed batten 140-n) together in this stowed state. Compression panel 130-n may unfold during the deployment of the flexible membrane system 100-n and remain at a root of the flexible membrane system 100-n during the deployment. Foam panels 120-n-1 and 120-n-2 may be positioned with respect to fold 111-n of flexible membrane 110-n-2 in the stowed state such that elements 114-n-1 and 114-n-2, for example, of flexible membrane 110-n-2 are protected in the stowed state.

Flexible membrane 110-n-1 may be referred to as a first flexible membrane and/or central membrane, while flexible membrane 110-n-2 may be referred to as a second flexible membrane or outer flexible membrane. Flexible membrane 110-n-2 may be stacked in fold state on flexible membrane 110-n-1 in folded state. Flexible membranes 110-n-1 and 110-n-2 may be coupled with each other through one or more hinges, such as hinges 124-n-1 and 124-n-2, coupled with one or more of foam panels, such as foam panels 120-n-3 and 120-n-4, coupled with flexible membrane 110-n-1 and one or more foam panels, such as foam panels 120-n-1 and 120-n-2, coupled with the flexible membrane 110-n-2.

FIG. 14A and FIG. 14B show aspects of a system 100-o in accordance with various embodiments. System 100-o may be an example of or used in conjunction with aspects of the systems and/or the methods of FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 15A, FIG. 15B, FIG. 15C, FIG. 16A, FIG. 16B, FIG. 17A, and/or FIG. 17B. System 100-o may highlight various hinges, such as hinge 124-o-1 and 124-o-2 that couple foam panels, such as foam panels 120-o-1, 120-o-2, 120-o-3, and 120-o-4, with each other between separate flexible membranes, such as a central flexible membrane 110-o-1 and an outer flexible membrane 110-o-2. The hinges 124-o-1 and 124-o-2 may be spring-loaded and/or honeycombed. Hinges 124-o may include features to allow lanyards to be routed to facilitate motor moderation of the flip out. FIG. 14A shows the system 100-o as the hinges 124-o-1 and 124-o-2 rotate the outer flexible membrane 110-o-2 with foam panels 120-o-1 and 120-o-2 in a stowed state with respect to the central flexible membrane 110-o-1 with foam panels 120-o-3 and 120-o-4 in a stowed state. FIG. 14B shows these components when the rotation has completed, forming a linear configuration before section or bay deployment. FIG. 14B also highlights the hinge portions in the linear configuration. System 100-o may reflect the deployment of system 100-n of FIG. 13A and FIG. 13B.

FIG. 15A, FIG. 15B, and FIG. 15C show aspects of a system 100-p in accordance with various embodiments. System 100-p may be an example of or used in conjunction with aspects of the systems and/or the methods of FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 16B, FIG. 17A, and/or FIG. 17B. System 100-p may provide a stowed backside overview in the upper portion of FIG. 15A and stowed frontside overview in the lower portion of FIG. 15A, including components such as cup cone 129-p, multiple standoffs (such as standoff 193-p; in some embodiments, standoffs 193-p may be configured as cup cones) back compression panel 130-p-1, front compression panels 130-p-1 and 130-p-2, an HDRM (including a Frangibolt 19′7-p and Frangibolt actuator 198-p), a gimbal interface 199-p, and/or rate deployment lanyards 195-p-1, 195-p-2, and 195-p-3 with control motor 196-p and associated gear(s). Other components may be shown but not specifically called out, such as foam panels, bowed battens, foam hinges, and/or flexible membranes. FIG. 15B may show a cutaway side view of a Frangibolt layout in accordance with various embodiments, highlighting Frangibolt 19′7-p and Frangibolt actuator 198-p; multiple foam panels, such as foam panel 120-p-1, 120-p-2, and 120-p-3, and folded flexible membrane 110-p-1, 110-p-2, and 110-p3 may also be shown. System 100-p may provide aspects for deployment rate control. A HDRM, such as a preloaded Frangibolt 197-p, may be utilized. Outer compression panels 130-p-2 and 130-p-3 may be utilized, which may be left at the root after deployment begins. Foam hinges may also be shown along with battens that may be rotated for stowage and accommodated by cut outs in one or more of the foam panels. FIG. 15C shows aspects of a release of system 100-p in accordance with various embodiments. For example, a compression spring 192-p may push panel 130-p-1 out until a shoulder bolt 191-p seats in its counterbore. Shoulder bolt 191-p may remain preloaded to maintain root movement requirements. Cup cone 129-p may unseat from cup 128-p as seen going from upper to lower portion of FIG. 15C, which may clear gimbal 199-p to rotate.

FIG. 16A shows aspects of a system 100-q. System 100-q may be an example of or used in conjunction with aspects of the systems and/or the methods of FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16B, FIG. 17A, and/or FIG. 17B. For example, foam hinge 124-q may be used to couple foam panels 120-q-1 and 120-q-2. A cross beam hinge 127-q may couple cross beams across the bottoms of foam panels 120-q-1 and 120-q-2. A wiper arm outer column attachment 180-q, which may be referred to as an arm attachment, may also be shown that may attach to two corners of the outer flexible membrane 110-q-2 to help reduce wrinkles in the flexible membrane 110-q-2. The wiper arm outer column attachment 180-q may include a bar or beam portion along with a spreader portion to help reduce wrinkles in outer membrane 110-q-2. This may provide for an even load distribution along the length of the outer membrane 110-q-2. For example, arm attachment 180-q may be coupled with one or more outer corners of at least the tip section of the flexible membrane 110-q-2 such that one or more wrinkles in the flexible membrane 110-q-2 are reduced. FIG. 16A generally shows elements of flexible membrane 110-q-2, such as element 114-q-2. FIG. 16A also shows a central membrane 110-q-1 with a representative element 114-q-1. The portions of outer membrane 110-q-2 and central membrane 110-q-1 may form portions of the tip section of system 100-q. The arm attachment 180-q may thus generally refer to the tip section of flexible membrane 110-q-2. The general configuration of arm attachment 180-q may also be applicable to root sections of a section, such as the root sections of outer membrane 110-q-2. For example, an arm attachment like arm attachment 180-q may be coupled with one or more outer corners of a root section of the flexible membrane 110-q-2 such that one or more wrinkles in the flexible membrane 110-q-2 are reduced.

FIG. 16B shows aspects of a system 100-r. System 100-r may be an example of or used in conjunction with aspects of the systems and/or the methods of FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, FIG. 17A, and/or FIG. 17B. The upper portion of FIG. 16B shows aspects of an assembled structure that includes foam panel 120-r with related components, such as cross beam 123-r, foam panel hinge 124-r, a cup cone 129-r, and compression ring 194-r. The lower portion of FIG. 16B shows this structure in a disassembled state, which also shows shim stocks 132-r-1 and 132-r-2 and that foam panel 120-r may be formed from two foam pieces 120-r-1 and 120-r-2. In some embodiments, an additional foam panel 120-r with the related components may be coupled with the right most portion of cross beam 123-r. Foam panel(s) 120-r may also include one or more channels to accommodate different components such as bowed battens.

Turning now to FIG. 17A, a flow diagram of a method 1700 is shown in accordance with various embodiments. Method 1700 may be implemented utilizing a variety of systems and/or devices such as those shown and/or described with respect to FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, and/or FIG. 16B. Method 1700 may be referred to as a method of deployment of a flexible membrane system.

At block 1710, multiple sections of a flexible membrane may be deployed utilizing multiple distributed backing structures coupled with the flexible membrane to form the multiple sections of the flexible membrane. Some embodiments of the method include applying tension to the flexible membrane through multiple bowed battens from the multiple distributed backing structures that provide deployment force within the multiple sections of the flexible membrane. Some embodiments of the method include applying tension to one or more diagonals coupled with the flexible membrane through one or more of the bowed battens. Some embodiments include comprising pushing the multiple sections of the flexible membrane apart from each other during deployment utilizing one or more torque springs from the multiple distributed backing structures. Some embodiments of the method include tensioning one or more longerons utilizing the one or more torque springs as each section from the multiple sections of the flexible membrane deploys. In some embodiments, the one or more longerons include one or more tensioned cords.

Some embodiments of the method 1700 include folding the flexible membrane into a stowed state such that multiple foam panels coupled with the flexible membrane are positioned within one or more folds of the flexible membrane such that multiple elements of the flexible membrane are protected in the stowed state. Some embodiments of the method include extending the multiple foam panels perpendicular to the flexible membrane in a deployed state. Some embodiments of the method include compressing the flexible membranes and the multiple foam panels together in a stowed state utilizing one or more compression panels. Some embodiments of the method include unfolding the one or more compression panels during deployment of the flexible membrane where the one or more compression panels remain at a root of the flexible membrane during the deployment.

Some embodiments of the method 1700 include deploying the multiple sections of the flexible membrane sequentially. Some embodiments of the method include utilizing one or more latches to sequentially deploy one or more of the sections from the multiple sections of the flexible membrane. In some embodiments, at least one of the one or more latches controls deployment of a tip section of the multiple sections of the flexible membrane. In some embodiments, the at least one of the one or more latches that controls deployment of the tip section of the multiple sections of the flexible membrane is coupled with a penultimate section of the multiple sections of the flexible membrane with a tether.

Some embodiments of the method 1700 include separating one or more of the multiple bowed battens from the flexible membrane using one or more snubbers. Some embodiments of the method include positioning at least a portion of one or more of the multiple bowed battens within one or more channels formed in one of the multiple foam panels in the stowed state.

Some embodiments of the method 1700 include another flexible membrane in a folded state stacked on the flexible membrane in a folded state. Some embodiments of the method include rotating the other flexible membrane in the folded state to position lateral to the flexible membrane in the folded state for deployment and deploying the other flexible membrane as the multiple sections of the flexible membrane are deployed. Some embodiments of the method include tensioning the other flexible membrane from a root of the other flexible membrane to a tip of the other flexible membrane. Some embodiments of the method include reducing one or more wrinkles of the other flexible membrane utilizing one or more arm attachments coupled with one or more outer corners of the tip section of the other membrane. Some embodiments include tensioning the other flexible membrane utilizing one or more connections between the foam panels, such as the foam panels coupled with the flexible membrane and the other flexible membrane.

FIG. 17B shows a flow diagram of a method 1700-a in accordance with various embodiments. Method 1700-a may be implemented utilizing a variety of systems and/or devices such as those shown and/or described with respect to FIG. 1, FIG. 2A, FIG. 2B, FIG. 3A, FIG. 3B, FIG. 4, FIG. 5, FIG. 6, FIG. 7, FIG. 8, FIG. 9A, FIG. 9B, FIG. 9C, FIG. 9D, FIG. 10A, FIG. 10B, FIG. 10C, FIG. 11A, FIG. 11B, FIG. 11C, FIG. 12, FIG. 13A, FIG. 13B, FIG. 14A, FIG. 14B, FIG. 15A, FIG. 15B, FIG. 15C, FIG. 16A, and/or FIG. 16B. Method 1700-a may be an example of method 1700.

At block 1705, one or more outer compression panels and/or one or more flexible membranes may rotate out to a linear configuration. The compression panel(s) generally stay at the root of the system once rotated. At block 1710-a, one or more flexible membranes may unfold from their root end to form a first bay or section. One or more foam panels may be integrally coupled and stowed with the flexible membranes. At block 1720, one or more of the foam panels may extend perpendicular to the one or more flexible membranes at distributed locations along the backsides of the flexible membranes as deployment proceeds. The distribution of foam panels may generally demarcate boundaries between successive bays of the system. One or more bowed battens may facilitate deployment of each bay. One or more torque springs may also facilitate deployment from bay to bay. One or more longerons and/or diagonal(s) may be tensioned as the system deploys from the root to the tip.

These embodiments may not capture the full extent of combinations and permutations of materials and process equipment. However, they may demonstrate the range of applicability of the methods, devices, and/or systems. The different embodiments may utilize more or less stages than those described.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various stages may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the embodiments.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which may be depicted as a flow diagram or block diagram or as stages. Although each may describe the operations as a sequential process, many of the operations can be performed in parallel or concurrently. In addition, the order of the operations may be rearranged. A process may have additional stages not included in the figure.

Having described several embodiments, it will be recognized by those of skill in the art that various modifications, alternative constructions, and equivalents may be used without departing from the spirit of the different embodiments. For example, the above elements may merely be a component of a larger system, wherein other rules may take precedence over or otherwise modify the application of the different embodiments. Also, a number of stages may be undertaken before, during, or after the above elements are considered. Accordingly, the above description should not be taken as limiting the scope of the different embodiments.

1. A flexible membrane system comprising:
one or more flexible membranes; and
a plurality of distributed backing structures coupled with at least one of the one or more flexible membranes to form a plurality of sections from the at least one of the one or more flexible membranes.

2. The system of claim 1, wherein the one or more flexible membranes include one or more solar array blankets.

3. The system of claim 1, wherein the plurality of distributed backing structures includes a plurality of foam panels.

4. The system of claim 3, wherein the plurality of foam panels are positioned with respect to one or more folds of the at least one of the one or more flexible membranes in a stowed state such that one or more elements of the at least one of the one or more flexible membranes are protected in the stowed state.

5. The system of claim 4, wherein the plurality of foam panels extend perpendicular to the at least one of one or more flexible membranes in a deployed state.

6. The system of claim 1, further comprising one or more compression panels that compress the at least one of the one or more flexible membranes and the plurality of distributed backing structures together in a stowed state.

7. The system of claim 6, wherein the one or more compression panels unfold during deployment of the flexible membrane system and remain at a root of the flexible membrane system during the deployment.

8. The system of claim 6, further comprising a plurality of foam panels positioned with respect to one or more folds of the at least one of the one or more flexible membranes in the stowed state such that one or more elements of the at least one of the one or more flexible membranes are protected in the stowed state.

9. The system of claim 1, wherein the plurality of distributed backing structures include a plurality of bowed battens that apply tension to the at least one of the one or more flexible membranes that provide deployment force within the plurality of sections formed from the at least one of the one or more flexible membranes.

10. The system of claim 9, wherein the plurality of bowed battens include a plurality of pairs of bowed battens, wherein each pair of bowed battens forms a crossed configuration for a respective section from the plurality of sections of the at least one of the one or more flexible membranes.

11. The system of claim 9, wherein one or more of a plurality of foam panels include one or more channels that accommodate one or more of the plurality of bowed battens in the stowed state.

12. The system of claim 9, wherein the plurality of distributed backing structures include one or more torque springs that push the plurality of sections apart from each other during deployment.

13. The system of claim 12, wherein the plurality of distributed backing structures includes one or more longerons that are put under tension from the one or more torque springs as each section from the plurality of sections deploy.

14. The system of claim 13, wherein the one or more longerons include one or more tensioned cords.

15. The system of claim 13, wherein the plurality of distributed backing structures include one or more diagonals that are tensioned by at least the one or more bowed battens or the one or more torque springs and form a distributed truss structure with the one or more longerons.

16. The system of claim 9, wherein the plurality of distributed backing structures include one or more longerons and one or more diagonals that form a distributed truss structure, wherein the one or more diagonals and the one or more longerons are tensioned by the one or more bowed battens.

17. The system of claim 9, further comprising one or more snubbers positioned to separate the one or more of the plurality of bowed battens from the at least one of the one or more flexible membranes.

18. The system of claim 1, further comprising one or more latches that control sequential deployment of one or more of the sections from the plurality of sections of the at least one or more of the flexible membranes.

19. The system of claim 1, wherein the one or more flexible membranes are configured to Z-fold.

20. The system of claim 1, further comprising one or more lanyards that control deployment of the plurality of sections of the at least one of the one or more flexible membranes.

21. The system of claim 1, wherein the one or more flexible membranes include a first flexible membrane as the at least one of the one or more flexible membranes and a second flexible membrane such that the second flexible membrane is stacked in a folded state on the first flexible membrane in a folded state.

22. The system of claim 21, wherein the first membrane and the second membrane are coupled with each other through one or more hinges coupled with one or more of foam panels coupled with the first membrane and one or more foam panels coupled with the second membrane.

23. The system of claim 21, wherein the second flexible membrane is tensioned from a root section of the second flexible membrane to a tip section of the second flexible membrane.

24. The system of claim 23, further comprising one or more arm attachments coupled with one or more outer corners of at least the tip section of the second flexible membrane such that one or more wrinkles in the second flexible membrane are reduced.

25.-44. (canceled)
